(19) United States
(12) Patent Application Publication
(10) Pub. No.: US 2025/0317165 A1
(43) Pub. Date: Oct. 9, 2025

(54) INTERFERENCE MITIGATION IN REFLECTIVE INTELLIGENT SURFACE-BASED COMMUNICATION SYSTEMS

(71) Applicant: QUALCOMM INCORPORATED, San Diego, CA (US)

(72) Inventors: Min Huang, Beijing (CN); Chao Wei, Beijing (CN); Hao Xu, Beijing (CN)

(21) Appl. No.: 18/865,627

(22) PCT Filed: Aug. 5, 2022
(86) PCT No.: PCT/CN2022/110531

§ 371 Date: Nov. 13, 2024

(51) Int. Cl. H04B 7/04

(52) U.S. Cl. CPC H04B 7/04013

(57) ABSTRACT

Methods, systems, and devices for wireless communications are described. A network entity may transmit a control signal indicating a configuration of radio resources for communicating signals to a controller of a reconfigurable intelligent surface (RIS). The network entity may exchange the signals with one or more wireless devices via a set of reflective elements of the RIS. The network entity may determine a set of restricted locations (e.g., angles, positions, or both) for the signals reflected by the RIS and corresponding restriction types. The network entity may transmit the set of restricted locations and restriction types to a controller of the RIS. The controller of the RIS may generate a weighting matrix to control the set of reflective elements of the RIS to reflect the signals according to the radio resources and based on the set of restricted locations and corresponding restriction types.

### CROSS REFERENCE

The present Application is a 371 national stage filing of International PCT Application No. PCT/CN2022/110531 by Huang et al. entitled “INTERFERENCE MITIGATION IN REFLECTIVE INTELLIGENT SURFACE-BASED COMMUNICATION SYSTEMS,” filed Aug. 5, 2022, which is assigned to the assignee hereof, and which is expressly incorporated by reference in its entirety herein.

### FIELD OF TECHNOLOGY

The following relates to wireless communications, including interference mitigation in reflective intelligent surface (RIS)-based communication systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support interference mitigation in reflective intelligent surface (RIS)-based communication systems. For example, the described techniques provide for a network entity to transmit control signaling indicating a set of restricted locations and corresponding restriction types to a controller of a RIS, such that the RIS may generate a weighting matrix according to the restricted locations. For example, the network entity may transmit a set of restricted angles, positions, or both explicitly or implicitly (e.g., via reference signals) to the controller of the RIS. The network entity may also transmit a radio resource configuration for communicating signals between the network entity and one or more wireless devices (e.g., user equipment (UEs)) via the RIS. The RIS controller may apply a weighting matrix to one or more reflective elements of the RIS to reflect the signals according to the configuration and in accordance with the restricted locations and restriction types. Thus, the network entity and the UE may communicate with each other via the RIS, while mitigating interference for one or more wireless devices in the restricted locations.

A method for wireless communication at a network entity is described. The method may include transmitting, to a RIS, first control signaling indicating a configuration of radio resources for communicating signals between the network entity and one or more wireless devices via a set of reflective elements of the RIS, determining a set of restricted locations for the signals reflected by the RIS and one or more restriction types associated with the set of restricted locations, and transmitting, to the RIS, second control signaling indicating the set of restricted locations and the one or more restriction types associated with the set of restricted locations.

An apparatus for wireless communication at a network entity is described. The apparatus may include a processor, memory coupled with the processor, and instructions stored in the memory. The instructions may be executable by the processor to cause the apparatus to transmit, to a RIS, first control signaling indicating a configuration of radio resources for communicating signals between the network entity and one or more wireless devices via a set of reflective elements of the RIS, determine a set of restricted locations for the signals reflected by the RIS and one or more restriction types associated with the set of restricted locations, and transmit, to the RIS, second control signaling indicating the set of restricted locations and the one or more restriction types associated with the set of restricted locations.

Another apparatus for wireless communication at a network entity is described. The apparatus may include means for transmitting, to a RIS, first control signaling indicating a configuration of radio resources for communicating signals between the network entity and one or more wireless devices via a set of reflective elements of the RIS, means for determining a set of restricted locations for the signals reflected by the RIS and one or more restriction types associated with the set of restricted locations, and means for transmitting, to the RIS, second control signaling indicating the set of restricted locations and the one or more restriction types associated with the set of restricted locations.

A non-transitory computer-readable medium storing code for wireless communication at a network entity is described. The code may include instructions executable by a processor to transmit, to a RIS, first control signaling indicating a configuration of radio resources for communicating signals between the network entity and one or more wireless devices via a set of reflective elements of the RIS, determine a set of restricted locations for the signals reflected by the RIS and one or more restriction types associated with the set of restricted locations, and transmit, to the RIS, second control signaling indicating the set of restricted locations and the one or more restriction types associated with the set of restricted locations.

In some examples of the method, apparatuses, and non-transitory computer-readable medium described herein, transmitting the second control signaling indicating the set of restricted locations may include operations, features, means, or instructions for transmitting, to the RIS, an identification of each restricted location of the set of restricted locations.

In some examples of the method, apparatuses, and non-transitory computer-readable medium described herein, transmitting the second control signaling indicating the set of restricted locations may include operations, features, means, or instructions for transmitting, to the RIS, an indication of a set of reference signals from the network entity for the RIS to determine the set of restricted locations.

In some examples of the method, apparatuses, and non-transitory computer-readable medium described herein, transmitting the second control signaling indicating the set of restricted locations may include operations, features, means, or instructions for transmitting, to the RIS, a set of restricted angles and a restriction type associated with each restricted angle.

In some examples of the method, apparatuses, and non-transitory computer-readable medium described herein, transmitting the second control signaling indicating the set of restricted locations may include operations, features, means, or instructions for transmitting, to the RIS, a set of restricted angles and associated distances and a restriction type associated with each restricted angle and associated distance.

In some examples of the method, apparatuses, and non-transitory computer-readable medium described herein, the second control signaling includes a downlink control information (DCI) message, a media access control-control element (MAC-CE), radio resource control (RRC) signaling, or a sequence.

In some examples of the method, apparatuses, and non-transitory computer-readable medium described herein, a single control message includes the first control signaling and the second control signaling.

In some examples of the method, apparatuses, and non-transitory computer-readable medium described herein, a first control message includes the first control signaling and a second control message includes the second control signaling.

Some examples of the method, apparatuses, and non-transitory computer-readable medium described herein may further include operations, features, means, or instructions for receiving an indication of interference value from at least one wireless device of the one or more wireless devices and adding, to the set of restricted locations, a restricted location associated with the at least one wireless device based on the interference value exceeding a threshold interference value.

Some examples of the method, apparatuses, and non-transitory computer-readable medium described herein may further include operations, features, means, or instructions for receiving, from a wireless node, joint scheduling information, determining that interference exists for at least one wireless device of the one or more wireless devices, and adding, to the set of restricted locations, a restricted location associated with the at least one wireless device based on the interference existing.

A method for wireless communication at a RIS is described. The method may include receiving first control signaling indicating a configuration of radio resources for communicating signals between a network entity and one or more wireless devices via a set of reflective elements of the RIS, receiving, from the network entity, second control signaling indicating a set of restricted locations for the signals reflected by the RIS and one or more restriction types associated with the set of restricted locations, and controlling the set of reflective elements of the RIS to reflect the signals according to the configuration based on the set of restricted locations and the one or more restriction types.

An apparatus for wireless communication at a RIS is described. The apparatus may include a processor, memory coupled with the processor, and instructions stored in the memory. The instructions may be executable by the processor to cause the apparatus to receive first control signaling indicating a configuration of radio resources for communicating signals between a network entity and one or more wireless devices via a set of reflective elements of the RIS, receive, from the network entity, second control signaling indicating a set of restricted locations for the signals reflected by the RIS and one or more restriction types associated with the set of restricted locations, and control the set of reflective elements of the RIS to reflect the signals according to the configuration based on the set of restricted locations and the one or more restriction types.

Another apparatus for wireless communication at a RIS is described. The apparatus may include means for receiving first control signaling indicating a configuration of radio resources for communicating signals between a network entity and one or more wireless devices via a set of reflective elements of the RIS, means for receiving, from the network entity, second control signaling indicating a set of restricted locations for the signals reflected by the RIS and one or more restriction types associated with the set of restricted locations, and means for controlling the set of reflective elements of the RIS to reflect the signals according to the configuration based on the set of restricted locations and the one or more restriction types.

A non-transitory computer-readable medium storing code for wireless communication at a RIS is described. The code may include instructions executable by a processor to receive first control signaling indicating a configuration of radio resources for communicating signals between a network entity and one or more wireless devices via a set of reflective elements of the RIS, receive, from the network entity, second control signaling indicating a set of restricted locations for the signals reflected by the RIS and one or more restriction types associated with the set of restricted locations, and control the set of reflective elements of the RIS to reflect the signals according to the configuration based on the set of restricted locations and the one or more restriction types.

In some examples of the method, apparatuses, and non-transitory computer-readable medium described herein, receiving the second control signaling indicating the set of restricted locations may include operations, features, means, or instructions for receiving, from the network entity, an identification of each restricted location of the set of restricted locations.

In some examples of the method, apparatuses, and non-transitory computer-readable medium described herein, receiving the second control signaling indicating the set of restricted locations may include operations, features, means, or instructions for receiving an indication of a set of reference signals from the network entity and determining, by the RIS, the set of restricted locations based on the set of restricted locations corresponding to the set of reference signals.

In some examples of the method, apparatuses, and non-transitory computer-readable medium described herein, receiving the second control signaling indicating the set of restricted locations may include operations, features, means, or instructions for receiving, from the network entity, a set of restricted angles and a restriction type associated with each restricted angle.

In some examples of the method, apparatuses, and non-transitory computer-readable medium described herein, receiving the second control signaling indicating the set of restricted locations may include operations, features, means, or instructions for receiving, from the network entity, a set of restricted angles and associated distances and a restriction type associated with each restricted angle and associated distance.

Some examples of the method, apparatuses, and non-transitory computer-readable medium described herein may further include operations, features, means, or instructions for selecting, for each reflective element of the set of reflective elements of the RIS, a reflection configuration based on the set of restricted locations, the one or more restriction types, or both.

In some examples of the method, apparatuses, and non-transitory computer-readable medium described herein, the reflection configuration includes a coefficient amplitude and phase value for the each reflective element.

In some examples of the method, apparatuses, and non-transitory computer-readable medium described herein, controlling the set of reflective elements may include operations, features, means, or instructions for identifying that interference exists between a location of the one or more wireless devices and a restricted location and generating a set of reflection coefficients for the set of reflective elements based on the set of restricted locations and the one or more restriction types.

In some examples of the method, apparatuses, and non-transitory computer-readable medium described herein, controlling the set of reflective elements may include operations, features, means, or instructions for identifying a lack of interference between a location of the one or more wireless devices and a restricted location and generating a set of reflection coefficients for the set of reflective elements exclusive of the set of restricted locations and the one or more restriction types.

In some examples of the method, apparatuses, and non-transitory computer-readable medium described herein, the second control signaling includes a DCI message, a MAC-CE, RRC signaling, or a sequence.

In some examples of the method, apparatuses, and non-transitory computer-readable medium described herein, a single control message includes the first control signaling and the second control signaling.

In some examples of the method, apparatuses, and non-transitory computer-readable medium described herein, a first control message includes the first control signaling and a second control message includes the second control signaling.

### BRIEF DESCRIPTION OF THE DRAWINGS

FIGS. 1 and 2 illustrate examples of wireless communications systems that support interference mitigation in reflective intelligent surface (RIS)-based communication systems in accordance with one or more aspects of the present disclosure.

FIG. 3 illustrates an example of a process flow that supports interference mitigation in RIS-based communication systems in accordance with one or more aspects of the present disclosure.

FIGS. 4 and 5 show block diagrams of devices that support interference mitigation in RIS-based communication systems in accordance with one or more aspects of the present disclosure.

FIG. 6 shows a block diagram of a communications manager that supports interference mitigation in RIS-based communication systems in accordance with one or more aspects of the present disclosure.

FIG. 7 shows a diagram of a system including a device that supports interference mitigation in RIS-based communication systems in accordance with one or more aspects of the present disclosure.

FIGS. 8 and 9 show block diagrams of devices that support interference mitigation in RIS-based communication systems in accordance with one or more aspects of the present disclosure.

FIG. 10 shows a block diagram of a communications manager that supports interference mitigation in RIS-based communication systems in accordance with one or more aspects of the present disclosure.

FIG. 11 shows a diagram of a system including a device that supports interference mitigation in RIS-based communication systems in accordance with one or more aspects of the present disclosure.

FIGS. 12 through 16 show flowcharts illustrating methods that support interference mitigation in RIS-based communication systems in accordance with one or more aspects of the present disclosure.

### DETAILED DESCRIPTION

Some wireless communications systems may implement one or more reconfigurable intelligent surfaces (RISs) to reflect signaling towards a target device (e.g., a UE or a network entity) to extend coverage for wireless communication devices. In some examples, a RIS may alternatively be referred to as a channel engineering device (CED). A RIS may use one or more elements (e.g., reflective elements) to reflect, or propagate, a wave in a desired direction in a process called RIS reflection beamforming. Such reflection may refer to or include refraction, or propagation, and in some cases be referred to generally as deflection (e.g., refraction, reflection, or both). During RIS reflection beamforming, the RIS may reflect a main lobe of a reflection beam toward the target device, and the sidelobes of the beam may point in different directions. The sidelobes of the beam may cause interference at a non-target device for a signal from another wireless device (e.g., because one or more of the sidelobes may point toward another wireless device, which may also be referred to as a non-target device). Additionally, or alternatively, signals from the other wireless device to the non-target device may cause interference for signals to the target device due to the RIS reflecting the signals from the other wireless device toward the target device. The interference from the sidelobes of the beam to the target device may impact reception and decoding of the signals to the non-target device, while the interference from the signals to the non-target device may impact reception and decoding of the signals to the target device.

In some examples, a RIS may use restricted location information to reduce interference at one or more wireless devices (e.g., from sending signals intended for a target device toward non-target devices or signals intended for a non-target device to target devices). The restricted location information may include beam angles and/or distances from the RIS that the RIS should not utilize to reflect a signal. The RIS may have reflective elements, each of which may be separately configured (e.g., using phase and amplitude values). In some cases, the RIS may adjust the reflective elements by calculating a weighting matrix to apply to the reflective elements using the restriction information. The RIS may calculate different values for the weighting matrix depending on whether the transmitting and receiving devices are far field (e.g., greater than a threshold distance away) or near field (e.g., less than a threshold distance away). The network entity may explicitly signal each restricted location to the RIS, or the network entity may implicitly signal the indication of reference signals that each corresponds to a restricted location.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to interference mitigation in RIS-based communication systems.

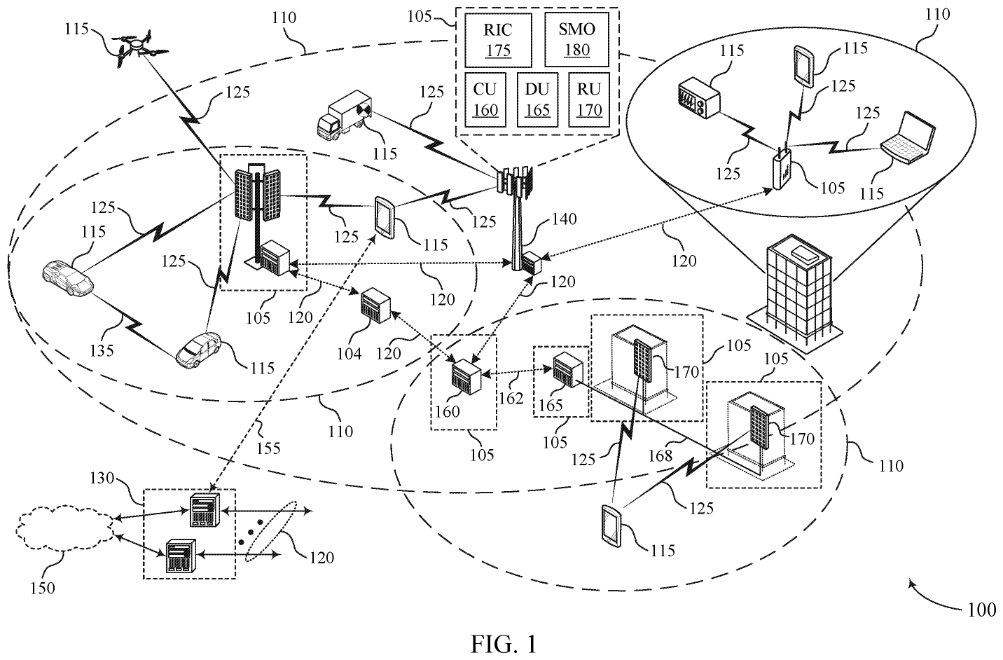

FIG. 1 illustrates an example of a wireless communications system 100 that supports interference mitigation in RIS-based communication systems in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support interference mitigation in RIS-based communication systems as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A network entity 105 may transmit a control signal indicating a configuration of radio resources for communicating signals to a controller of a RIS. The network entity 105 may exchange the signals with one or more wireless devices (e.g., a UE 115 or another network entity 105) via a set of reflective elements of the RIS. The network entity may determine a set of restricted locations (e.g., angles, positions, or both) for the signals reflected by the RIS and corresponding restriction types. The network entity 105 may transmit the set of restricted locations and restriction types to a controller of the RIS. The controller of the RIS may generate a weighting matrix to control the set of reflective elements of the RIS to reflect the signals according to the radio resources and based on the set of restricted locations and corresponding restriction types.

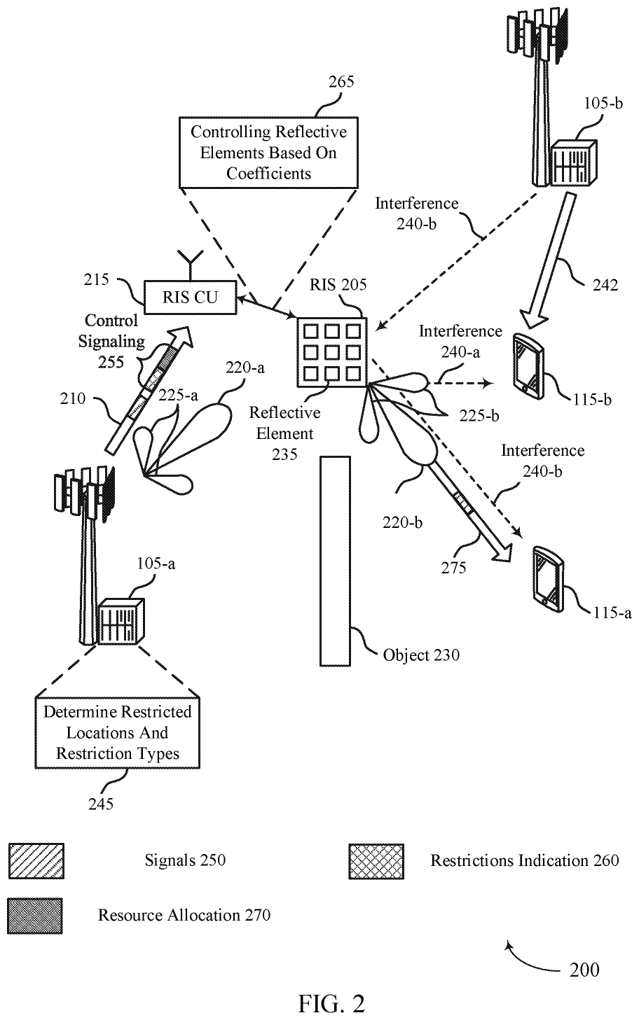

FIG. 2 illustrates an example of a wireless communications system 200 that supports interference mitigation in RIS-based communication systems in accordance with one or more aspects of the present disclosure. The wireless communications system 200 may implement or be implemented to realize aspects of the wireless communications system 100. For example, the wireless communications system 200 illustrates communication between a UE 115-a, a UE 115-b, a network entity 105-a, and a network entity 105-b, which may be examples of corresponding devices described herein, including with reference to FIG. 1. In some cases, the UE 115-a and the network entity 105-a may establish communications via a RIS 205 by controlling the RIS in accordance with a set of restricted locations and restriction types.

In some examples, the wireless communications system 200 may employ massive MIMO (e.g., 5G massive MIMO) to increase an achievable throughput between two communicating devices. For example, the wireless communications system 200 may achieve relatively high beamforming gain by using one or more active antenna units (AAU), individual radio frequency chains per antenna port, or the like. However, using AAUs to increase throughput may cause relatively high power consumption. Thus, the wireless communications system may implement one or more RISs 205 to extend coverage with negligible increase to power consumption.

In some cases, network entity 105-a may establish a communication link 210 for transmitting or receiving control signaling, data, or both to and from UE 115-a via the RIS 205, which may be a near passive device (e.g., may not have power amplifiers). In some cases, the network entity 105-a may be an example of a base station, as described with reference to FIG. 1. The network entity 105-a may be in communication with one or more other network entities, such as a controller of the RIS (e.g., a RIS CU 215). The RIS CU 215 may be referred to as a network entity, or any other controlling device, and may communicate with the network entity 105-a via the communication link 210.

In some cases, a network entity 105-a and a UE 115-a may attempt to establish a communication link 210 with each other using a beamforming technique and via an assisting device controlled by an assisting node. In some aspects, such an assisting device may include or be an example of a RIS 205, and such an assisting node may include or be an example of a RIS CU 215 or some other device capable of CU functionality (e.g., any device capable of wirelessly transmitting or receiving or capable of configuring or otherwise controlling one or more assisting devices). The RIS 205 may be a near-passive device capable of reflecting an impinging or incident wave to a desired location or in a desired direction.

As illustrated by the wireless communications system 200, a network entity 105-a may communicate with a UE 115-a by using a RIS 205 to reflect one or more beams, such as a beam with a main lobe 220-a and one or more sidelobes 225-a, to a UE 115-a around an object 230. In some cases, the object 230 may block or otherwise inhibits a line-of-sight (LoS) link between the network entity 105-a and the UE 115-a. The beam from the RIS 205 may have a main lobe 220-b and one or more sidelobes 225-b. A RIS CU 215 may configure a reflection characteristic of the RIS 205 to control the reflection direction from the RIS 205. For example, the RIS CU 215 may control one or more reflective elements 235 of the RIS 205 to create the main lobe 220-b and may also result in the sidelobes 225-b. In some cases, the network entity 105-a may configure or control the RIS CU 215, such that the network entity 105-a may effectively configure or control the reflection direction of the RIS 205. For example, a network entity 105-a may transmit messaging to the RIS CU 215 indicating a configuration of the RIS 205 and the RIS CU 215 may configure the RIS 205 accordingly. In some aspects, a configuration of the RIS 205 may be for a receive beam, such as a directional beam or configuration for directional “reception” of signaling, and a reflected beam, such a directional beam or configuration for directional reflection of the signaling. Further, although described herein as a “receive” beam, a receive beam associated with a configuration of the RIS 205 may refer to reception as part of a reflecting (as opposed to, for example, as part of a decoding). In some examples, wireless communications system 200 may illustrate an example of transmissions from a network entity 105-a to a UE 115-a. In some other examples, the transmissions may be from the UE 115-a to the network entity 105-a, from a UE to UE 115-a, or any combination thereof.

A RIS 205 may function similarly to a mirror or other reflective surface in its ability to reflect incident beams or waves (such as light waves), but may differ in that a RIS 205 may include one or more components that may control how an incident beam or wave is reflected (such that an angle of incidence can be different than an angle of reflection). Additionally, or alternatively, the RIS 205 may control a shape of a reflected beam or wave, such as via energy focusing or energy nulling via constructive interference or destructive interference, respectively. For example, a RIS 205 may include a quantity of reflective elements 235 that each have a controllable delay, phase, or polarization, or any combination thereof. The RIS CU 215 may configure each of the reflective elements 235 to control how an incident beam or wave may be reflected or to control a shape of a reflected beam or wave. A RIS 205 may be an example of or may otherwise be referred to as a software-controlled metasurface, a configurable reflective surface, a reflective intelligent surface, or a configurable intelligent surface, and may sometimes be a metal surface (e.g., a copper surface) including a quantity of reflective elements 235. In some aspects, a RIS CU 215 may be coupled with a RIS 205 via hardware (such as via a fiber optic cable). In some other aspects, a RIS CU 215 may be non-co-located with a RIS 205 and may configure the RIS 205 via over-the-air signaling.

In some examples, a transmitting wireless device, such as the network entity 105-a, may be relatively far from a receiving wireless device, such as the UE 115-a, which may be referred to as far field. Similarly, the transmitting wireless device may be relatively close to the receiving wireless device, which may be referred to as near field. In some cases, the network entity 105-a may determine a distance between the network entity 105-a and the UE 115-a to determine whether the UE 115-a is far field or near field. The network entity 105-a may compare the distance to a threshold, such that if the distance is greater than the threshold, the UE 115-a may be far field, and if the distance is less than the threshold, the UE 115-a my be near field. In some examples, the network entity 105-a may calculate the threshold according to a formula

$$( e . g . , 0.62 √ \frac{{D}^{3}}{λ} or \frac{2 {D}^{2}}{λ} ,$$

where D is an antenna array panel width and λ is a wavelength).

In some cases, when the distance between the transmitting wireless device and the target object, such as the UE 115-a or the network entity 105-a, is greater than the threshold (e.g., relatively long), the radio wave may be planar. For a planar wave, the wave front may be perpendicular to the radio wave propagation direction. In some other cases, when the distance between the transmitting wireless device and the target object is less than the threshold (e.g., relatively short), the radio wave may be non-planar. For a non-planar wave, the wave front may be spherical. For example, if the target object is far field, one or more angles, θₙ, between a transmitter antenna panel of a network entity 105-a and the receiver antenna panel of the UE 115-a may be the same, where n is the number of antenna panel pairs actively transmitting and receiving (e.g., Far-field: θ₁=θ₂=θ₃). That is, each antenna element of the transmitter may send signals to a single antenna element of the receiver at an angle, θₙ, where θₙ is the same for each antenna element. In some other examples, if the target object is near field, one or more angles may be different for each antenna element of the transmitter, such that a target object may receive signals from each antenna element of the transmitter at different antenna elements of the receiver and according to different angles. That is, a first antenna element of the transmitter, Element 1, may send signals to multiple antenna elements of the receiver according to different angles (e.g., for 3 antenna elements at the receiver, Element 1 may send signals at angles θ₁, θ₂, θ₃, where θ₁≠θ₂≠θ₃). Similarly, a second antenna element of the transmitter, Element 2, may send signals to multiple antenna elements of the receiver according to different angles (e.g., for 3 antenna elements at the receiver, Element 2 may send signals at angles φ₁, φ₂, φ₃, where φ₁≠φ₂+≠φ₃). In some cases, the angles for Element 1 may be different than the angles for Element 2 (e.g., θᵢ≠φᵢ, where i may be a number of antenna elements at the receiver, and i=1˜3).

In some examples, if the transmitter or receiver lie in the far-field of a surface of the RIS 205, when a signal is transmitted toward the RIS 205 at incident angle θᵢ, the equivalent channel response value of the nth reflective element 235 of the RIS 205 at a reflection angle θᵣ is calculated according to Equation 1:

$${h}_{n} = {e}^{j \frac{2 π {d}_{n}}{λ} ( {sin θ}_{i} + {sin θ}_{r} )} \cdot {α}_{n} {e}^{j {φ}_{n}} \qquad ( 1 )$$

where

$${α}_{n} {e}^{j {φ}_{n}}$$

is the reflection coefficient of the reflective element 235, dₙ is the distance between the nth reflective element 235 to the reference reflective element 235 (Element 0), λ is wavelength. Similarly, the overall equivalent channel response value of the all the reflective elements 235, N, of the RIS 205 at reflection angle θᵣ is calculated according to Equation 2:

$$h = {\sum }_{n = 0}^{N - 1} {h}_{n} = {\sum }_{n = 0}^{N - 1} {e}^{j \frac{2 π {d}_{n}}{λ} ( {sin θ}_{i} + {sin θ}_{r} )} \cdot {α}_{n} {e}^{j {φ}_{n}} \qquad ( 2 )$$

Thus, if the reflection coefficient satisfies

$${α}_{n} ≡ α , {φ}_{n} = - \frac{2 π {d}_{n}}{λ} ( sin {θ}_{i} + sin {θ}_{r} ) ,$$

then the reflected beam (e.g., the main lobe 220-b) may point to the direction θᵣ. However, the RIS CU 215 may select a coefficient amplitude and phase values of each meta-element (e.g., reflective element 235) from a set {(a₁,ϕ₁), (a₂,ϕ₂), . . . , (a_{M}, ϕ_{M})} according to different configurations, such that an actual beam shape may deviate from a calculated beam shape. The number of reflective elements 235 at the RIS 205 may be directly proportional to the accuracy of the beam shape and direction.

In some other examples, if the transmitter or receiver lie in the near-field of the surface of the RIS 205, the incident angles θ_{i,n} or reflected angles θ_{r,n} of multiple meta-elements (e.g., reflective elements 235) may be different. The distance between the transmitter, receiver, or both and the nth reflective element 235, d_{i,n} and d_{r,n}, respectively, may be calculated based on the position of the reflective element 235, the orientation of the RIS 205, and the position of the transmitter, receiver, or both relative to the RIS 205. Thus, the network entity 105-a may select a coefficient amplitude and phase, an and On, of each reflective element 235 in relation to d_{i,n} and d_{r,n}, which depend on both the direction and distance of the transmitter and receiver relative to the RIS 205. When the transmitter (e.g., the network entity 105-a, the UE 115-a, or both) sends a signal toward an nth reflective element 235 at an incident distance d_{i,n}, the equivalent channel response value of the nth reflective element 235 of the RIS 205 at a reflection distance d_{r,n} is calculated according to Equation 3:

$${h}_{n} = {e}^{j \frac{2 π ( ( {d}_{i , n} - {d}_{i , 0} ) + ( {d}_{r , n} - {d}_{r , 0} ) )}{λ}} \cdot {α}_{n} {e}^{j {φ}_{n}} . \qquad ( 3 )$$

Similarly, the overall equivalent channel response value of all of the reflective elements 235 of RIS at incident position with incident distances

$${\{ {d}_{i , n} \}}_{n = 0}^{N - 1}$$

is calculated according to Equation 4:

$$h = {\sum }_{n = 0}^{N - 1} {h}_{n} = {\sum }_{n = 0}^{N - 1} {e}^{j \frac{2 π ( ( {d}_{i , {n}^{-}} {d}_{i , 0} ) + ( {d}_{r , n} - {d}_{r , 0} ) )}{λ}} \cdot {α}_{n} {e}^{j {φ}_{n}} \qquad ( 4 )$$

Thus, if the reflection coefficient satisfies

$${α}_{n} ≡ α , {φ}_{n} = - \frac{2 π ( ( {d}_{i , n} - {d}_{i , 0} ) + ( {d}_{r , n} - {d}_{r , 0} ) )}{λ} ,$$

then the reflected beam (e.g., the main lobe 220-b) may point to the reflection position with reflection distances

$${\{ {d}_{r , n} \}}_{n = 0}^{N - 1} .$$

However, the RIS CU 215 may determine aₙ and φₙ by selecting an available configuration with an amplitude and phase closest to the theoretical values.

In the wireless communications system 200, which may be a RIS-based communications system, during reflection beamforming by the RIS 205, when the RIS 205 generates the main lobe 220-b of the reflection beam toward a target device (e.g., UE 115-a), the sidelobes 225-b of this beam may point to other directions. In some examples, the network entity 105-a may configure the RIS 205 (e.g., via the RIS CU 215) to reduce a strength of the sidelobes 225-b of the reflection beam in one or more directions (e.g., a direction of a non-target UE 115-b, another network entity 105-b, an object, or the like). However, when the RIS 205 generates reflection beam towards the target UE 115-a, the sidelobes 225-b of this beam may cause interference 240-a to a non-target UE 115-b, which may be receiving signals from another network node, such as network entity 105-b.

In some other cases, the network entity 105-a may configure the RIS 205 (e.g., via the RIS CU 215) to reduce a reflected signal in an interference direction to the target beamforming direction. However, when the RIS 205 reflects a communication signal to the direction of the target UE 115-a, a signal from another simultaneous-transmitting network entity 105-b (e.g., with a known direction relative to the RIS 205) may arrive at the RIS 205. For example, the RIS 205 may receive at least a portion of a signal between a network entity 105-b and a UE 115-b via a communication link 242 between the network entity 105-b and the UE 115-b. The RIS 205 may reflect the signal between the network entity 105-b and the UE 115-b to the target UE 115-a, and thus may cause interference 240-b at the target UE 115-a. In some cases, the network entity 105-b that causes the interference 240-b may be a network entity 105-b for a neighboring-cell. Additionally, or alternatively, a UE 115-b may cause the interference 240-b (e.g., by not coordinating with the network entity 105-a, the network entity 105-b, or both). In some cases, the interference 240-a may cause a UE 115-b to fail to successfully communicate with the network entity 105-b, while the interference 240-b may cause the UE 115-a to fail to successfully communicate with the network entity 105-a.

In some examples, the network entity 105-a may indicate a set of restricted locations and restriction types to the RIS CU 215 for controlling the reflective elements 235 of the RIS 205, which may reduce interference for communications between the UE 115-a, the UE 115-b, the network entity 105-a, and the network entity 105-b. In some examples, at 245, the network entity 105-a may determine a set of restricted locations for signals 250 reflected by the RIS 205 and one or more restriction types for the restricted locations. For example, the network entity 105-a may determine whether a target UE 115-a, a non-target UE 115-b, another network entity 105-b (e.g., an interference wireless node), or any combination thereof are far field or near field of the RIS 205 by using network deployment and dimensioning (e.g., comparing a distance to a calculated threshold).

Additionally, or alternatively, for far field and near field, the network entity 105-a may determine a direction, a position, or both of the target UE 115-a, the non-target UE 115-b, the other network entity 105-b, or any combination thereof relative to the RIS 205. The network entity 105-a may determine the direction, the position, or both by transmitting reference signals toward the RIS 205, and the RIS may sweep the beams to multiple directions and positions to account for the far field and near field coverage. The target UE 115-a, the non-target UE 115-b, and the other network entity 105-b may perform one or more measurements on the reference signals (a reference signal receive power (RSRP) measurement, a signal-to-noise ratio (SNR), channel quality indicator (CQI) etc.) and may select and/or report a beam with a strongest received gain.

In some examples, the network entity 105-a may determine whether the interference 240-a to the non-target UE 115-b or the interference 240-b from another wireless node (e.g., the network entity 105-b, the UE 115-b, or both) exists for each slot, where a slot is a dynamic scheduling unit in the time-domain that may be dedicated for uplink signaling, downlink signaling, or mixed uplink and downlink signaling. The network entity 105-a may determine whether the interference 240-a, the interference 240-b, or both exist for each slot by utilizing a joint scheduling condition of the network entity 105-a and the other wireless node (e.g., by a central scheduling unit). In some other examples, the network entity 105-a may assume the interference 240-a and the interference 240-b exist in each slot.

In some wireless communications systems (e.g., RIS-based communications systems, such as the wireless communications system 200), the network entity 105-a may configure the RIS 205 via the RIS CU 215 and the communication link 210 to reflect one or more signals 250. If an interference node (e.g., the non-target UE 115-b, the network entity 105-b, or both for the interference 240-a and the interference 240-b) is in the far field of the RIS 205, the network entity 105-a may transmit control signaling 255 to the RIS CU 215 indicating one or more restricted direction angles and an associated restriction type (e.g., reflection-restricted or incident-restricted direction angles). For example, the network entity 105-a may transmit a control message, such as a DCI message, a MAC-CE, RRC signaling, or the like, with a restrictions indication 260 including the restricted direction angles and the associated restriction type. The restriction type may indicate whether a reflection direction angle from the RIS 205 to the UE 115-a is restricted, or whether an incident direction angle from the network entity 105-b to the RIS 205 is restricted.

For example, a reflection restriction may be a direction or position to which the RIS 205 should not reflect the signals 250, which may be referred to as a reflection restricted direction or a reflection restricted position and may be denoted as θᵣᵣ or pᵣᵣ, respectively. Said another way, the network entity 105-a may configure the reflection beamforming gain from θ_{incident} of p_{incident} to θᵣᵣ or pᵣᵣ to be lower than a threshold value. In some other examples, an incident restriction may be a direction or position from which the RIS 205 should not reflect an interference signal (e.g., the interference 240-b), which may be referred to as an incident restricted direction or an incident restricted position and may be denoted as Bᵢᵣ Or Pᵢᵣ, respectively. That is, the network entity 105-a may configure the reflection beamforming gain from θᵢᵣ or pᵢᵣ to a θ_{target} or p_{target} to be lower than a threshold value, where @_{target} of P_{target} means a target reflection direction (e.g., angle) or a target reflection position. The network entity 105-a may calculate the threshold value for the beamforming gain, or the threshold value may be otherwise defined (e.g., preconfigured).

The RIS CU 215 may receive the control signaling 255 with the restrictions indication 260 (e.g., with directions, positions, or both that are incident restricted or reflection restricted), and may generate reflection coefficients for the reflective elements 235 of the RIS 205 to realize the expected reflection restricted effect or incident restricted effect. For example, the RIS CU 215 may generate reflection coefficients for the reflective elements 235 that provide for the RIS 205 to reflect in directions or positions that do not include the reflection and/or incident restricted positions, directions, or both. In some examples, the RIS CU 215 may determine whether the interference 240-a, the interference 240-b, or both exist based on receiving the restrictions indication 260 (e.g., if the network entity 105-a indicates θᵣᵣ, θᵢᵣ, pᵣᵣ or pᵢᵣ, or any combination thereof). If interference exist, the RIS CU 215 may generate reflection restricted coefficient weights, wᵣᵣ, or incident restricted coefficient weights, wᵢᵣ, based on θᵣᵣ, θᵢᵣ, pᵣᵣ, pᵢᵣ, or any combination thereof. Otherwise, the RIS CU 215 may generate the reflection coefficients regardless of (e.g., that do not account for) θᵣᵣ, θᵢᵣ, pᵣᵣ, or pᵢᵣ. At 265, the RIS CU 215 may control the reflective elements 235 based on the generated coefficients.

In some examples, the RIS CU 215 may use one or more algorithms to generate non-restricted coefficients, reflection restricted coefficients, incident restricted coefficients, or any combination thereof. For example, for a far field interference node (e.g., if the UE 115-b, the network entity 105-b, or both are far field) to compute a non-restricted coefficient vector, wₙᵣ, the RIS CU 215 may use Equation 5:

$${w}_{nr} = [ 1 , {e}^{- j \frac{2 π {d}_{n}}{λ} ( sin {θ}_{target} + sin {θ}_{incident} )} , … , {e}^{- j \frac{2 π {d}_{n} ( N - 1 )}{λ} ( sin {θ}_{target} + sin {θ}_{incident} )} ] . \qquad ( 5 )$$

Similarly, to compute the reflection restricted coefficient weights, wᵣᵣ, (e.g., for the interference 240-a) the RIS CU 215 may first compute a restriction steering vector for the reflection restriction, uᵣᵣ, using Equation 6:

$${u}_{rr} = [ 1 , {e}^{j \frac{2 π {d}_{n}}{λ} ( sin {θ}_{rr} + sin {θ}_{incident} )} , … , {e}^{j \frac{2 π {d}_{n} ( N - 1 )}{λ} ( sin {θ}_{rr} + sin {θ}_{incident} )} ] , \qquad ( 6 )$$

where an orthogonal-projection matrix of uᵣᵣ is

$${P}_{rr} = I - {u}_{rr}^{H} {u}_{rr} ,$$

that satisfies uᵣᵣPᵣᵣ=0. Thus, the RIS CU 215 may then calculate wᵣᵣ according to Equation 7:

$${w}_{rr} = exp ( j \cdot quantization ( phase ( {P}_{rr} \cdot {w}_{nr} ) ) ) . \qquad ( 7 )$$

For the quantization, the RIS CU 215 may select a closest configuration phase of a reflective element 235 from the set of available phases (e.g., based on a configured table for implementation).

Additionally, or alternatively, the RIS CU 215 may compute incident restricted coefficient weights, wᵢᵣ, (e.g., for the interference 240-b), by first computing a restriction steering vector for the incident restriction, uᵢᵣ, using Equation 8:

$${u}_{ir} = [ 1 , {e}^{j \frac{2 π {d}_{n}}{λ} ( sin {θ}_{target} + sin {θ}_{ir} )} , … , {e}^{j \frac{2 π {d}_{n} ( N - 1 )}{λ} ( sin {θ}_{target} + sin {θ}_{ir} )} ] , \qquad ( 8 )$$

where an orthogonal-projection matrix of uᵢᵣ is

$${P}_{rr} = I - {u}_{ir}^{H} {u}_{ir} ,$$

that satisfies uᵢᵣPᵢᵣ=0. Thus, the RIS CU 215 may then calculate wᵢᵣ according to Equation 9:

$${w}_{ir} = exp ( j \cdot quantization ( phase ( {P}_{ir} \cdot {w}_{nr} ) ) ) . \qquad ( 9 )$$

For the quantization, the RIS CU 215 may select a closest configuration phase of a reflective element 235 from the set of available phases (e.g., based on a configured table for implementation). In some cases, the RIS CU 215 may use any of Equations 5through 9, or any other algorithm, to calculate the coefficients for the reflective elements 235 of the RIS 205.

In some examples, if there are multiple interference restrictions (e.g., an incident and reflection restriction for both the interference 240-a and the interference 240-b) for far field devices, the RIS CU 215 may calculate a combined steering matrix,

$$U = [ {u}_{rr}^{T} , {u}_{ir}^{T} ] ,$$

using the steering vector for the reflection restriction and the steering vector for the incident restriction. The RIS CU 215 may perform an eigenvalue decomposition (EVD), also known as the eigendecomposition, to UU^{H} to generate a null subspace, Vₙᵤₗₗ. Then, the RIS CU 215 may use Equation 10 to calculate a final multi-interference-restriction coefficients vector:

$${w}_{multi} = exp ( j \cdot quantization ( phase ( {V}_{null} \cdot {w}_{nr} ) ) ) \qquad ( 10 )$$

In some other examples, for a near field interference node (e.g., if the UE 115-b, the network entity 105-b, or both are near field) to compute a non-restricted coefficient vector, wₙᵣ, the RIS CU 215 may use Equation 11:

$${w}_{nr} = [ 1 , {e}^{- j \frac{2 π ( ( {d}_{i , 1} - {d}_{i , 0} ) + ( {d}_{r , 1} - {d}_{r , 0} ) )}{λ}} , … , {e}^{- j \frac{2 π ( ( {d}_{i , N - 1} - {d}_{i , 0} ) + ( {d}_{r , N - 1} - {d}_{r , 0} ) )}{λ}} ] \qquad ( 11 )$$

Similarly, to compute the reflection restricted coefficient weights, wᵣᵣ, (e.g., for the interference 240-a) the RIS CU 215 may first compute a restriction steering vector for the reflection restriction, uᵣᵣ, using Equation 12:

$${u}_{rr} = [ 1 , {e}^{j \frac{2 π ( {d}_{i , 1} - {d}_{i , 0} + {l}_{1} - {l}_{0} )}{λ}} , … , {e}^{j \frac{2 π ( {d}_{i , N - 1} - {d}_{i , 0} + {l}_{N - 1} - {l}_{0} )}{λ}} ] , \qquad ( 12 )$$

where lᵢ is the distance between the ith reflective element 235 of the RIS 205 and the interference node (e.g., the non-target UE 115-b) and an orthogonal-projection matrix of uᵣᵣ is

$${P}_{rr} = I - {u}_{rr}^{H} {u}_{rr}$$

that satisfies uᵣᵣPᵣᵣ=0. Thus, the RIS CU 215 may then calculate wᵣᵣ according to Equation 7.

Additionally, or alternatively, the RIS CU 215 may compute incident restricted coefficient weights, wᵢᵣ, (e.g., for the interference 240-b), by first computing a restriction steering vector for the incident restriction, wᵢᵣ, using Equation 13:

$${u}_{ir} = [ 1 , {e}^{j \frac{2 π ( {d}_{r , 1} - {d}_{r , 0} + {l}_{1} - {l}_{0} )}{λ}} , … , {e}^{j \frac{2 π ( {d}_{r , N - 1} - {d}_{r , 0} + {l}_{N - 1} - {l}_{0} )}{λ}} ] , \qquad ( 13 )$$

where lᵢ is the distance between the ith reflective element 235 of the RIS 205 and the interference node (e.g., the network entity 105-b) and an orthogonal-projection matrix of uᵤᵣ is

$${P}_{ir} = I - {u}_{ir}^{H} {u}_{ir} ,$$

that satisfies uᵢᵣPᵢᵣ=0. Thus, the RIS CU 215 may then calculate wᵢᵣ according to Equation 9. In some cases, the RIS CU 215 may use any of Equations 5 through 13, or any other algorithm, to calculate the coefficients for the reflective elements 235 of the RIS 205.

In some examples, the network entity 105-a may transmit a resource allocation 270 to the UE 115-a via the RIS 205. For example, the resource allocation 270 may indicate a configuration for radio resources (e.g., time-frequency resources) for communicating the signals 250 between the network entity 105-a and the UE 115-a via the reflective elements 235 of the RIS 205. The network entity 105-a may transmit the resource allocation 270 in control signaling 255, such as in a same control message as the restrictions indication 260 or in a different control message (e.g., DCI message, MAC-CE, RRC signaling, or the like) than the restrictions indication 260. In some cases, the network entity 105-a may transmit the signals 250 to the UE 115-a via the RIS 205 using the radio resource configuration, such as by using the communication link 210 and a communication link 275 between the RIS 205 and the UE 115-a. For example, the RIS CU 215 may apply the weighting matrix to the RIS 205 that accounts for the restrictions indication 260 (e.g., the weighting matrix calculated according to Equations 5 through 13) to reflect the signals 250 from the network entity 105-a to the UE 115-a without causing the interference 240-a or the interference 240-b. Additionally, or alternatively, the RIS 205 may reflect signals from the UE 115-a to the network entity 105-a according to a similar method. By mitigating the interference, the received signal SINR of a target UE 115-a or a non-target UE 115-b may increase, and thus the communication performance may improve.

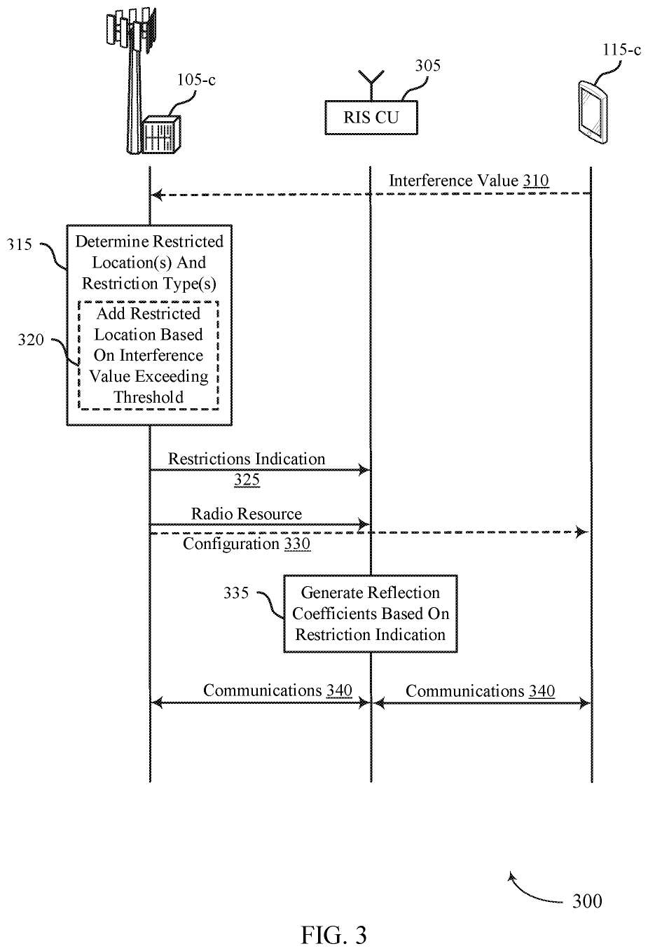

FIG. 3 illustrates an example of a process flow 300 that supports interference mitigation in RIS-based communication systems in accordance with one or more aspects of the present disclosure. In some examples, the process flow 300 may implement aspects of the wireless communications system 100 and the wireless communications system 200. The process flow 300 may illustrate an example of a network entity 105-b transmitting a resource allocation and restrictions indication to a RIS controller, such as RIS CU 305, where the RIS controller generates a weighting matrix to apply to reflective elements of the RIS for beamforming based on the restrictions indication. The network entity 105-c, the UE 115-c, and RIS CU 305 may be examples of a network entity 105, a UE 115, and a RIS CU 215 as described with reference to FIGS. 1 and 2. Alternative examples of the following may be implemented, where some processes are performed in a different order than described or are not performed. In some cases, processes may include additional features not mentioned below, or further processes may be added.

In some examples, the RIS CU 305 may be referred to as a network entity. The actions performed by the network entity 105-c may additionally, or alternatively, be performed by a controlling UE for sidelink communications.

At 310, the network entity 105-c may receive an indication of an interference value from a wireless device. The wireless device may be a UE 115-c, which may be a target UE for communications from the network entity 105-c, a non-target UE, or another network entity. In some other cases, the network entity 105-c may receive joint scheduling information from a wireless node (e.g., another network entity). The network entity 105-c may determine interference exists for at least one wireless device (e.g., a target UE, a non-target UE, the wireless node, or any combination thereof).

At 315, the network entity 105-c may determine a set of restricted locations for signals reflected by the RIS controlled by the RIS CU 305 and one or more restriction types for the set of restricted locations (e.g., incident restriction, reflection restriction, or both). For example, the network entity 105-c may determine an incident direction angle, position, or both (e.g., θ_{incident} or p_{incident}); a target direction angle, position, or both (e.g., θ_{target} or p_{target}); a set of restriction direction angles, positions, or both (e.g., θᵣᵣ, θᵢᵣ, or pᵣᵣ, pᵢᵣ); or any combination thereof. The network entity 105-c may also determine respective restriction types for the restriction direction angles, positions, or both. For example, the type of each restriction may be either a reflection restriction or an incident restriction, as described with reference to FIG. 2.

In some cases, at 320, the network entity 105-c may add a restricted location to the determined restricted locations for the wireless device that reported the interference value at 310. For example, if the interference value exceeds a threshold interference value, the network entity 105-c may add the restricted location to a set of restricted locations. The threshold interference value may be configured by the network entity 105-c, or may be otherwise defined at the network entity 105-c (e.g., calculated or preconfigured). Similarly, the network entity 105-c may add a restricted location for a wireless device to the set of restricted locations based on interference existing for a joint channel condition at the wireless device (e.g., based on the joint scheduling information).

At 325, the network entity 105-c may transmit control signaling (e.g., a physical downlink control channel (PDCCH) message, a MAC-CE, RRC signaling, or pre-defined sequences) to the RIS CU 305 indicating the set of restricted locations and the corresponding restriction types for the set of restricted locations. For example, the control signaling may indicate the determined directions, positions, or both from 315 to the RIS CU 305. The RIS CU 305 may have an NR receiver with a receive antenna for receiving the control signaling. Additionally, or alternatively, the RIS itself may have the NR receiver.

In some cases, the restrictions indication may be an explicit indication of the direction angles, positions, or both. For example, the network entity 105-c may determine the position and orientation of the RIS, the position of a target UE (e.g., UE 115-c), the position of a non-target UE, or the position of an interference node (e.g., the non-target UE, another network entity, or the like), then the network entity 105-c may indicate the value of θᵣᵣ, θᵢᵣ, pᵣᵣ, or pᵢᵣ to the RIS, such as via the RIS CU 305. That is, the network entity 105-c may transmit an identification of each restricted location of the set of restricted locations to the RIS CU 305. In some other cases, the restrictions indication may be an implicit indication of the direction angles, positions, or both. For example, after the RIS performs a beam sweeping procedure, the network entity 105-c may forward an indication of a selected reference signal to the RIS, then RIS may determine the value of θᵣᵣ, θᵢᵣ, pᵣᵣ, or pᵢᵣ based on stored beam information for the reference signals. That is, the network entity 105-c may transmit an indication of a set of reference signals to the RIS CU 305 for the RIS CU 305 to determine the set of restricted locations.

The restrictions indication may include a set of restricted angles and a restriction type for each angle. Additionally, or alternatively, the restrictions indication may include a set of restricted angles and corresponding distances and a restriction type for each restricted angle and corresponding distance.

At 330, the network entity 105-c may transmit a control message indicating a configuration of radio resources (e.g., time-frequency resources) for communicating signals between the network entity 105-c and one or more wireless devices, such as the UE 115-c, via reflective elements of the RIS. In some cases, the network entity 105-c may transmit the radio resource configuration prior to determining and transmitting the set of restricted locations and restriction types. In some other cases, the network entity 105-c may transmit the radio resource configuration after determining and transmitting the set of restricted locations and restriction types. In some examples, the network entity 105-c may include the restrictions indication and the radio resource configuration in a same control message, or in a different control message.

At 335, the RIS CU 305 may control the set of reflective elements of the RIS to reflect one or more signals according to the configuration based on the set of restricted locations and the one or more restriction types. For example, the RIS CU 305 may select a reflection configuration for each reflective element of the set of reflective elements of the RIS based on the set of restricted locations (e.g., in accordance with Equations 5 through 13, as described with respect to FIG. 2). The reflection configuration may include a coefficient amplitude and phase value for each reflective element.

In some cases, the RIS CU 305 may determine whether interference exists based on θ_{incident} or p_{incident}, θ_{target} or p_{target}, θᵣᵣ or pᵣᵣ, θᵢᵣ or pᵢᵣ and the associated restriction type from the restrictions indication and the radio resource configuration. The RIS CU 305 may calculate, or preemptively calculate, a mapping table to show whether interference exists for each angle group {θ_{incident} or p_{incident}, θ_{target} or p_{target}, θᵣᵣ or pᵣᵣ, θᵢᵣ or pᵢᵣ} based on the reflective element configurations. If interference exists, the RIS CU 305 may generate reflection coefficients for reflective elements of the RIS based on θ_{incident} or p_{incident}, θ_{target} or p_{target}, θᵣᵣ or pᵣᵣ, θᵢᵣ or pᵢᵣ and the associated restriction type (e.g., based on Equations 5 through 13, as described with reference to FIG. 2). In some cases, a time latency of changing reflective element coefficients may be relatively small (e.g., 10 microseconds (μs)), such as smaller than a slot duration. In some other examples, if interference does not exist, the RIS CU 305 may generate reflection coefficients based on θ_{incident} or p_{incident}, θ_{target} or p_{target}.

At 340, the network entity 105-c may transmit a communication signal towards the RIS, and the RIS may reflect the communication signal towards the UE 115-c based on the generated reflection coefficients.

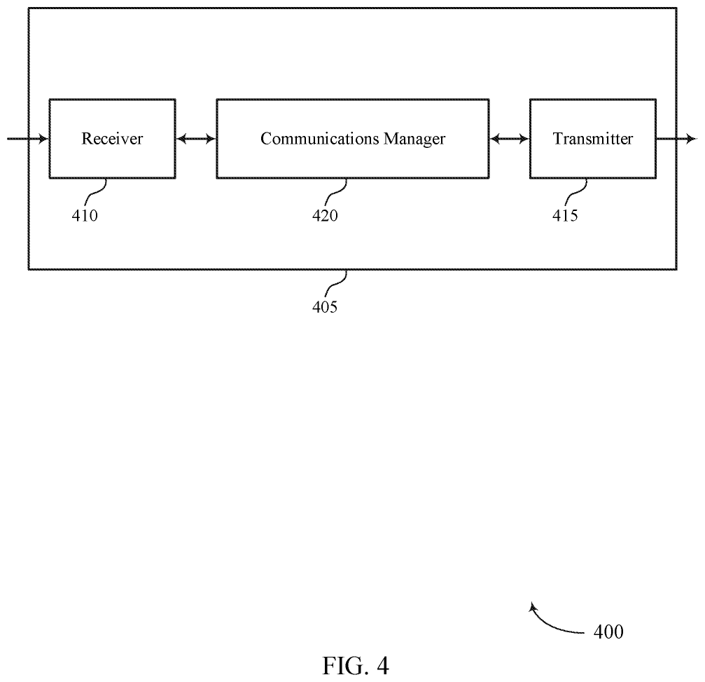

FIG. 4 shows a block diagram 400 of a device 405 that supports interference mitigation in RIS-based communication systems in accordance with one or more aspects of the present disclosure. The device 405 may be an example of aspects of a network entity 105 as described herein. The device 405 may include a receiver 410, a transmitter 415, and a communications manager 420. The device 405 may also include a processor. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations thereof or various components thereof may be examples of means for performing various aspects of interference mitigation in RIS-based communication systems as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a network entity in accordance with examples as disclosed herein. For example, the communications manager 420 may be configured as or otherwise support a means for transmitting, to a RIS, first control signaling indicating a configuration of radio resources for communicating signals between the network entity and one or more wireless devices via a set of reflective elements of the RIS. The communications manager 420 may be configured as or otherwise support a means for determining a set of restricted locations for the signals reflected by the RIS and one or more restriction types associated with the set of restricted locations. The communications manager 420 may be configured as or otherwise support a means for transmitting, to the RIS, second control signaling indicating the set of restricted locations and the one or more restriction types associated with the set of restricted locations.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for a network entity to transmit a resource allocation and restrictions indication to a RIS controller, where the RIS controller generates a weighting matrix to apply to reflective elements of the RIS for beamforming based on the restrictions indication, which may provide for reduced processing, reduced power consumption, more efficient utilization of communication resources, and the like.

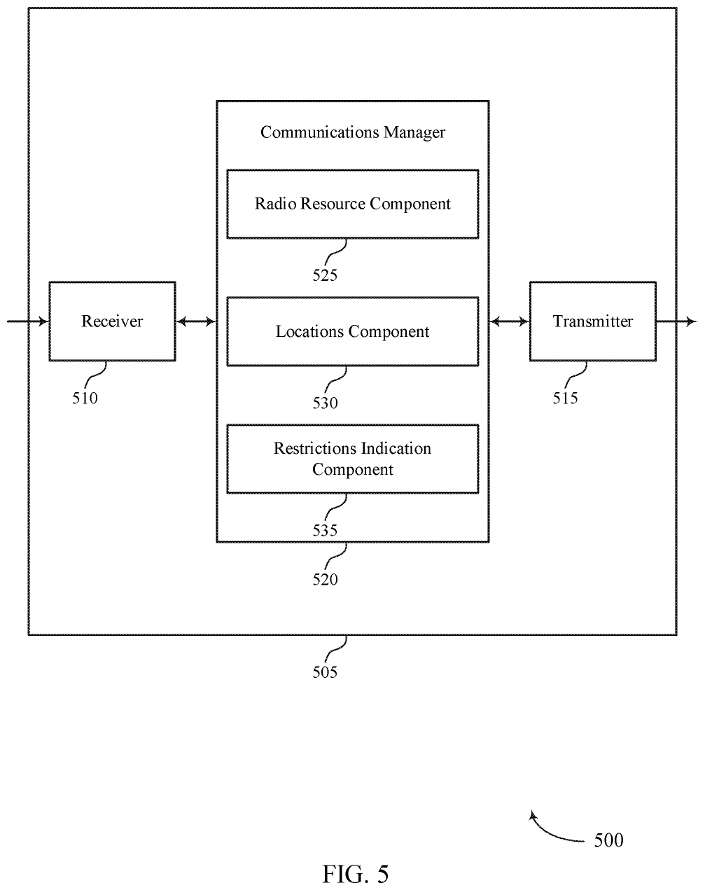

FIG. 5 shows a block diagram 500 of a device 505 that supports interference mitigation in RIS-based communication systems in accordance with one or more aspects of the present disclosure. The device 505 may be an example of aspects of a device 405 or a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of interference mitigation in RIS-based communication systems as described herein. For example, the communications manager 520 may include a radio resource component 525, a locations component 530, a restrictions indication component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a network entity in accordance with examples as disclosed herein. The radio resource component 525 may be configured as or otherwise support a means for transmitting, to a RIS, first control signaling indicating a configuration of radio resources for communicating signals between the network entity and one or more wireless devices via a set of reflective elements of the RIS. The locations component 530 may be configured as or otherwise support a means for determining a set of restricted locations for the signals reflected by the RIS and one or more restriction types associated with the set of restricted locations. The restrictions indication component 535 may be configured as or otherwise support a means for transmitting, to the RIS, second control signaling indicating the set of restricted locations and the one or more restriction types associated with the set of restricted locations.

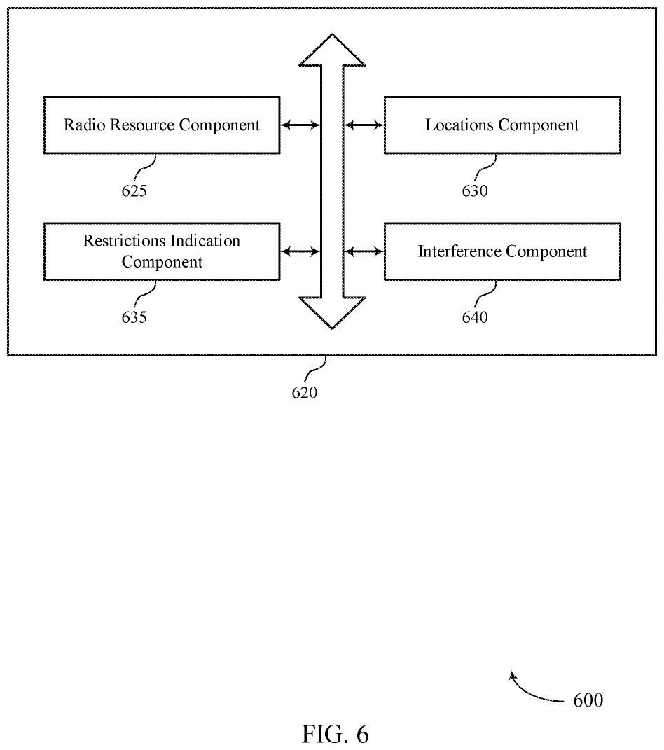

FIG. 6 shows a block diagram 600 of a communications manager 620 that supports interference mitigation in RIS-based communication systems in accordance with one or more aspects of the present disclosure. The communications manager 620 may be an example of aspects of a communications manager 420, a communications manager 520, or both, as described herein. The communications manager 620, or various components thereof, may be an example of means for performing various aspects of interference mitigation in RIS-based communication systems as described herein. For example, the communications manager 620 may include a radio resource component 625, a locations component 630, a restrictions indication component 635, an interference component 640, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 620 may support wireless communication at a network entity in accordance with examples as disclosed herein. The radio resource component 625 may be configured as or otherwise support a means for transmitting, to a RIS, first control signaling indicating a configuration of radio resources for communicating signals between the network entity and one or more wireless devices via a set of reflective elements of the RIS. The locations component 630 may be configured as or otherwise support a means for determining a set of restricted locations for the signals reflected by the RIS and one or more restriction types associated with the set of restricted locations. The restrictions indication component 635 may be configured as or otherwise support a means for transmitting, to the RIS, second control signaling indicating the set of restricted locations and the one or more restriction types associated with the set of restricted locations.

In some examples, to support transmitting the second control signaling indicating the set of restricted locations, the restrictions indication component 635 may be configured as or otherwise support a means for transmitting, to the RIS, an identification of each restricted location of the set of restricted locations.

In some examples, to support transmitting the second control signaling indicating the set of restricted locations, the restrictions indication component 635 may be configured as or otherwise support a means for transmitting, to the RIS, an indication of a set of reference signals from the network entity for the RIS to determine the set of restricted locations.

In some examples, to support transmitting the second control signaling indicating the set of restricted locations, the restrictions indication component 635 may be configured as or otherwise support a means for transmitting, to the RIS, a set of restricted angles and a restriction type associated with each restricted angle.

In some examples, to support transmitting the second control signaling indicating the set of restricted locations, the restrictions indication component 635 may be configured as or otherwise support a means for transmitting, to the RIS, a set of restricted angles and associated distances and a restriction type associated with each restricted angle and associated distance.

In some examples, the second control signaling includes a DCI message, a MAC-CE, RRC signaling, or a sequence.

In some examples, a single control message includes the first control signaling and the second control signaling.

In some examples, a first control message includes the first control signaling and a second control message includes the second control signaling.

In some examples, the interference component 640 may be configured as or otherwise support a means for receiving an indication of interference value from at least one wireless device of the one or more wireless devices. In some examples, the locations component 630 may be configured as or otherwise support a means for adding, to the set of restricted locations, a restricted location associated with the at least one wireless device based on the interference value exceeding a threshold interference value.

In some examples, the interference component 640 may be configured as or otherwise support a means for receiving, from a wireless node, joint scheduling information. In some examples, the interference component 640 may be configured as or otherwise support a means for determining that interference exists for at least one wireless device of the one or more wireless devices. In some examples, the locations component 630 may be configured as or otherwise support a means for adding, to the set of restricted locations, a restricted location associated with the at least one wireless device based on the interference existing.

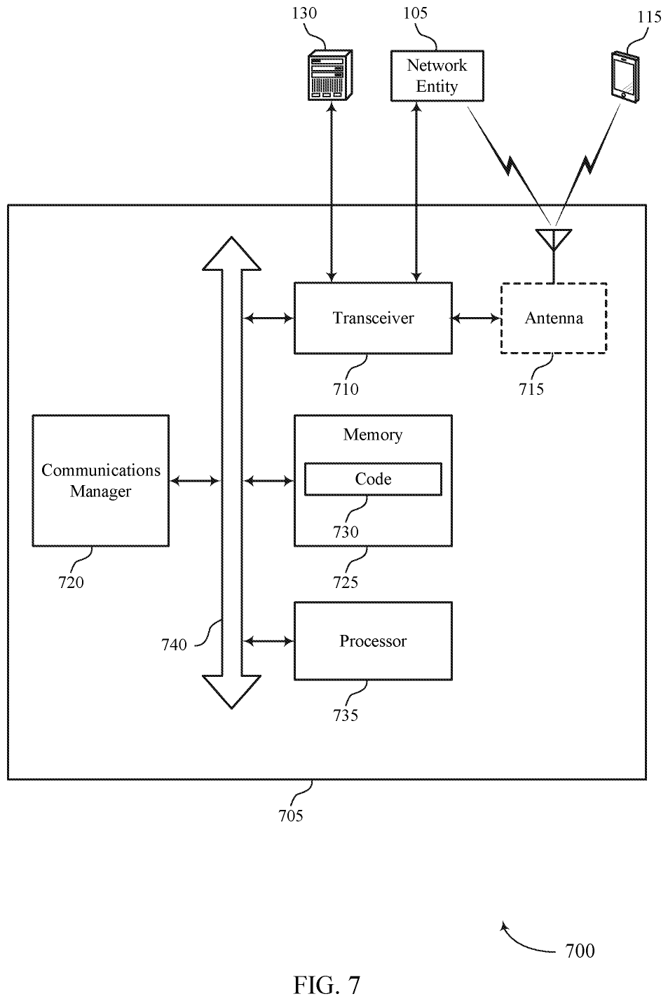

FIG. 7 shows a diagram of a system 700 including a device 705 that supports interference mitigation in RIS-based communication systems in accordance with one or more aspects of the present disclosure. The device 705 may be an example of or include the components of a device 405, a device 505, or a network entity 105 as described herein. The device 705 may communicate with one or more network entities 105, one or more UEs 115, or any combination thereof, which may include communications over one or more wired interfaces, over one or more wireless interfaces, or any combination thereof. The device 705 may include components that support outputting and obtaining communications, such as a communications manager 720, a transceiver 710, an antenna 715, a memory 725, code 730, and a processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or memory components (for example, the processor 735, or the memory 725, or both), may be included in a chip or chip assembly that is installed in the device 705. In some examples, the transceiver may be operable to support communications via one or more communications links (e.g., a communication link 125, a backhaul communication link 120, a midhaul communication link 162, a fronthaul communication link 168).

The memory 725 may include RAM and ROM. The memory 725 may store computer-readable, computer-executable code 730 including instructions that, when executed by the processor 735, cause the device 705 to perform various functions described herein. The code 730 may be stored in a non-transitory computer-readable medium such as system memory or another type of memory. In some cases, the code 730 may not be directly executable by the processor 735 but may cause a computer (e.g., when compiled and executed) to perform functions described herein. In some cases, the memory 725 may contain, among other things, a BIOS which may control basic hardware or software operation such as the interaction with peripheral components or devices.

The processor 735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 735 may be configured to operate a memory array using a memory controller. In some other cases, a memory controller may be integrated into the processor 735. The processor 735 may be configured to execute computer-readable instructions stored in a memory (e.g., the memory 725) to cause the device 705 to perform various functions (e.g., functions or tasks supporting interference mitigation in RIS-based communication systems). For example, the device 705 or a component of the device 705 may include a processor 735 and memory 725 coupled with the processor 735, the processor 735 and memory 725 configured to perform various functions described herein. The processor 735 may be an example of a cloud-computing platform (e.g., one or more physical nodes and supporting software such as operating systems, virtual machines, or container instances) that may host the functions (e.g., by executing code 730) to perform the functions of the device 705. The processor 735 may be any one or more suitable processors capable of executing scripts or instructions of one or more software programs stored in the device 705 (such as within the memory 725). In some implementations, the processor 735 may be a component of a processing system. A processing system may generally refer to a system or series of machines or components that receives inputs and processes the inputs to produce a set of outputs (which may be passed to other systems or components of, for example, the device 705). For example, a processing system of the device 705 may refer to a system including the various other components or subcomponents of the device 705, such as the processor 735, or the transceiver 710, or the communications manager 720, or other components or combinations of components of the device 705. The processing system of the device 705 may interface with other components of the device 705, and may process information received from other components (such as inputs or signals) or output information to other components. For example, a chip or modem of the device 705 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 705 may transmit information output from the chip or modem. Additionally, or alternatively, in some implementations, the one or more interfaces may refer to an interface between the processing system of the chip or modem and a receiver, such that the device 705 may obtain information or signal inputs, and the information may be passed to the processing system. A person having ordinary skill in the art will readily recognize that a first interface also may obtain information or signal inputs, and a second interface also may output information or signal outputs.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the memory 725, the code 730, and the processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with other network entities 105, and may include a controller or scheduler for controlling communications with UEs 115 in cooperation with other network entities 105. In some examples, the communications manager 720 may support an X2 interface within an LTE/LTE-A wireless communications network technology to provide communication between network entities 105.

The communications manager 720 may support wireless communication at a network entity in accordance with examples as disclosed herein. For example, the communications manager 720 may be configured as or otherwise support a means for transmitting, to a RIS, first control signaling indicating a configuration of radio resources for communicating signals between the network entity and one or more wireless devices via a set of reflective elements of the RIS. The communications manager 720 may be configured as or otherwise support a means for determining a set of restricted locations for the signals reflected by the RIS and one or more restriction types associated with the set of restricted locations. The communications manager 720 may be configured as or otherwise support a means for transmitting, to the RIS, second control signaling indicating the set of restricted locations and the one or more restriction types associated with the set of restricted locations.

By including or configuring the communications manager 720 in accordance with examples as described herein, the device 705 may support techniques for a network entity to transmit a resource allocation and restrictions indication to a RIS controller, where the RIS controller generates a weighting matrix to apply to reflective elements of the RIS for beamforming based on the restrictions indication, which may provide for improved communication reliability, reduced latency, improved user experience related to reduced processing, reduced power consumption, more efficient utilization of communication resources, improved coordination between devices, longer battery life, and the like.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, the processor 735, the memory 725, the code 730, or any combination thereof. For example, the code 730 may include instructions executable by the processor 735 to cause the device 705 to perform various aspects of interference mitigation in RIS-based communication systems as described herein, or the processor 735 and the memory 725 may be otherwise configured to perform or support such operations.

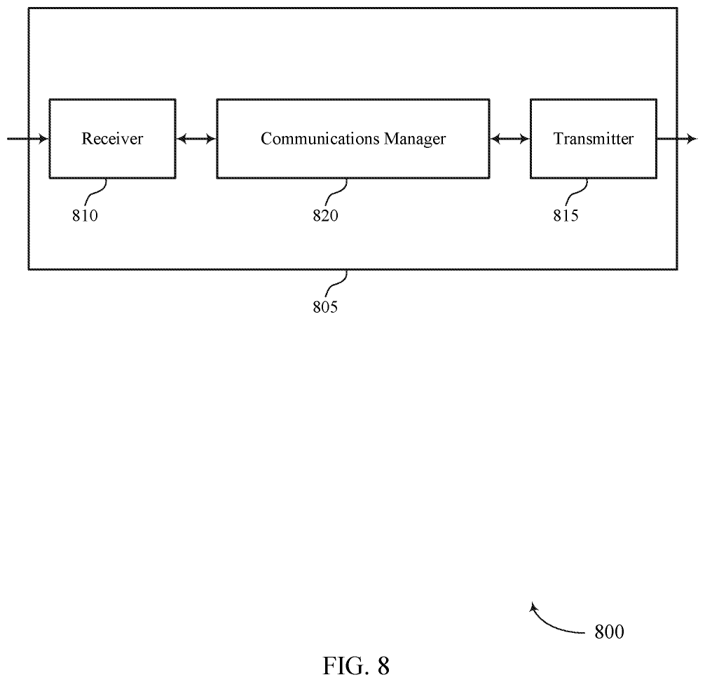

FIG. 8 shows a block diagram 800 of a device 805 that supports interference mitigation in RIS-based communication systems in accordance with one or more aspects of the present disclosure. The device 805 may be an example of aspects of a RIS controller as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to interference mitigation in RIS-based communication systems). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to interference mitigation in RIS-based communication systems). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of interference mitigation in RIS-based communication systems as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a RIS in accordance with examples as disclosed herein. For example, the communications manager 820 may be configured as or otherwise support a means for receiving first control signaling indicating a configuration of radio resources for communicating signals between a network entity and one or more wireless devices via a set of reflective elements of the RIS. The communications manager 820 may be configured as or otherwise support a means for receiving, from the network entity, second control signaling indicating a set of restricted locations for the signals reflected by the RIS and one or more restriction types associated with the set of restricted locations. The communications manager 820 may be configured as or otherwise support a means for controlling the set of reflective elements of the RIS to reflect the signals according to the configuration based on the set of restricted locations and the one or more restriction types.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for a network entity to transmit a resource allocation and restrictions indication to a RIS controller, where the RIS controller generates a weighting matrix to apply to reflective elements of the RIS for beamforming based on the restrictions indication, which may provide for reduced processing, reduced power consumption, more efficient utilization of communication resources, and the like.

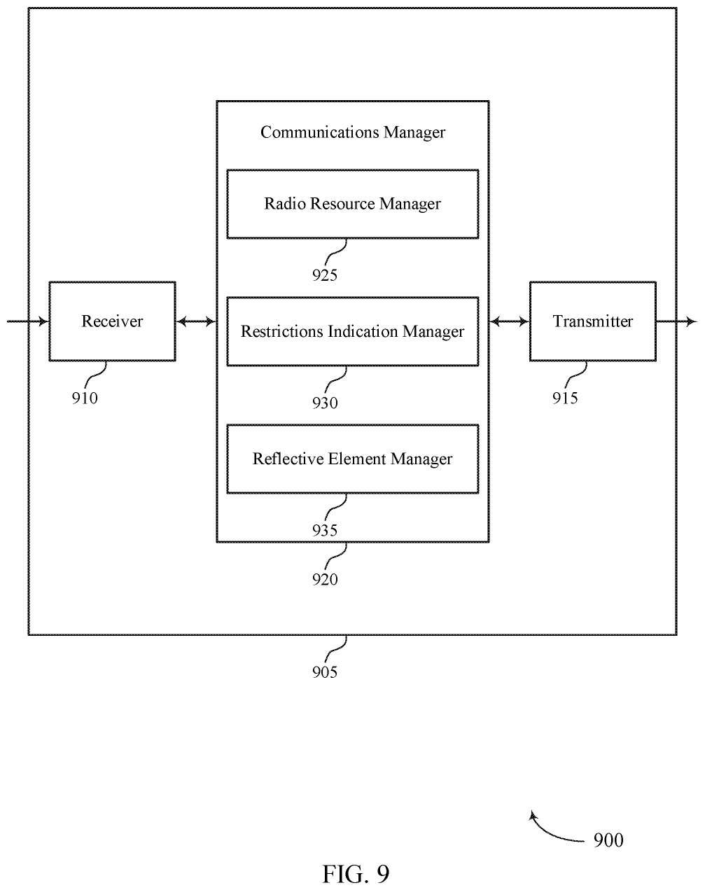

FIG. 9 shows a block diagram 900 of a device 905 that supports interference mitigation in RIS-based communication systems in accordance with one or more aspects of the present disclosure. The device 905 may be an example of aspects of a device 805 or a RIS controller 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to interference mitigation in RIS-based communication systems). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to interference mitigation in RIS-based communication systems). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of interference mitigation in RIS-based communication systems as described herein. For example, the communications manager 920 may include a radio resource manager 925, a restrictions indication manager 930, a reflective element manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a RIS in accordance with examples as disclosed herein. The radio resource manager 925 may be configured as or otherwise support a means for receiving first control signaling indicating a configuration of radio resources for communicating signals between a network entity and one or more wireless devices via a set of reflective elements of the RIS. The restrictions indication manager 930 may be configured as or otherwise support a means for receiving, from the network entity, second control signaling indicating a set of restricted locations for the signals reflected by the RIS and one or more restriction types associated with the set of restricted locations. The reflective element manager 935 may be configured as or otherwise support a means for controlling the set of reflective elements of the RIS to reflect the signals according to the configuration based on the set of restricted locations and the one or more restriction types.

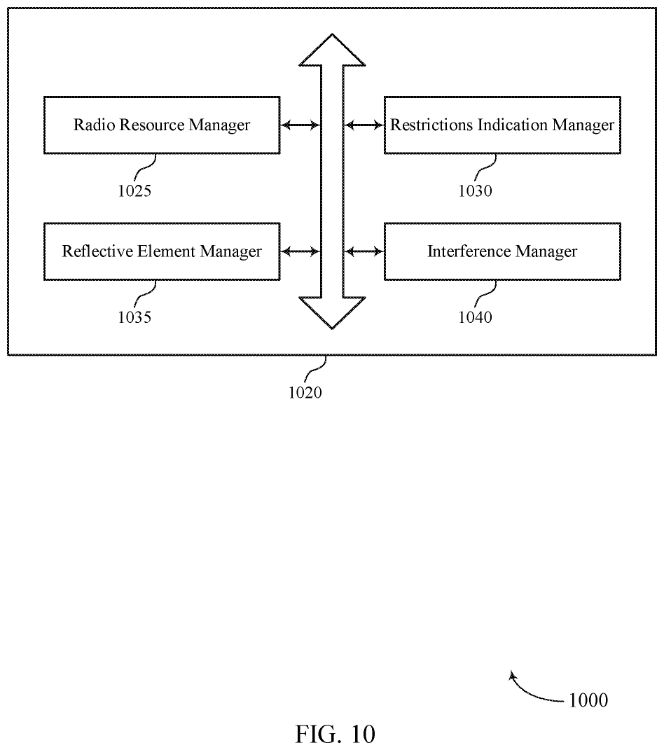

FIG. 10 shows a block diagram 1000 of a communications manager 1020 that supports interference mitigation in RIS-based communication systems in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of interference mitigation in RIS-based communication systems as described herein. For example, the communications manager 1020 may include a radio resource manager 1025, a restrictions indication manager 1030, a reflective element manager 1035, an interference manager 1040, or any combination thereof. Each of these components may communicate, directly or indirectly, with one another (e.g., via one or more buses).

The communications manager 1020 may support wireless communication at a RIS in accordance with examples as disclosed herein. The radio resource manager 1025 may be configured as or otherwise support a means for receiving first control signaling indicating a configuration of radio resources for communicating signals between a network entity and one or more wireless devices via a set of reflective elements of the RIS. The restrictions indication manager 1030 may be configured as or otherwise support a means for receiving, from the network entity, second control signaling indicating a set of restricted locations for the signals reflected by the RIS and one or more restriction types associated with the set of restricted locations. The reflective element manager 1035 may be configured as or otherwise support a means for controlling the set of reflective elements of the RIS to reflect the signals according to the configuration based on the set of restricted locations and the one or more restriction types.

In some examples, to support receiving the second control signaling indicating the set of restricted locations, the restrictions indication manager 1030 may be configured as or otherwise support a means for receiving, from the network entity, an identification of each restricted location of the set of restricted locations.

In some examples, to support receiving the second control signaling indicating the set of restricted locations, the restrictions indication manager 1030 may be configured as or otherwise support a means for receiving an indication of a set of reference signals from the network entity. In some examples, to support receiving the second control signaling indicating the set of restricted locations, the restrictions indication manager 1030 may be configured as or otherwise support a means for determining, by the RIS, the set of restricted locations based on the set of restricted locations corresponding to the set of reference signals.

In some examples, to support receiving the second control signaling indicating the set of restricted locations, the restrictions indication manager 1030 may be configured as or otherwise support a means for receiving, from the network entity, a set of restricted angles and a restriction type associated with each restricted angle.

In some examples, to support receiving the second control signaling indicating the set of restricted locations, the restrictions indication manager 1030 may be configured as or otherwise support a means for receiving, from the network entity, a set of restricted angles and associated distances and a restriction type associated with each restricted angle and associated distance.

In some examples, the reflective element manager 1035 may be configured as or otherwise support a means for selecting, for each reflective element of the set of reflective elements of the RIS, a reflection configuration based on the set of restricted locations, the one or more restriction types, or both.

In some examples, the reflection configuration includes a coefficient amplitude and phase value for the each reflective element.

In some examples, to support controlling the set of reflective elements, the interference manager 1040 may be configured as or otherwise support a means for identifying that interference exists between a location of the one or more wireless devices and a restricted location. In some examples, to support controlling the set of reflective elements, the reflective element manager 1035 may be configured as or otherwise support a means for generating a set of reflection coefficients or incident coefficients for the set of reflective elements based on the set of restricted locations and the one or more restriction types.

In some examples, to support controlling the set of reflective elements, the interference manager 1040 may be configured as or otherwise support a means for identifying a lack of interference between a location of the one or more wireless devices and a restricted location. In some examples, to support controlling the set of reflective elements, the reflective element manager 1035 may be configured as or otherwise support a means for generating a set of reflection coefficients or incident coefficients for the set of reflective elements exclusive of the set of restricted locations and the one or more restriction types.

In some examples, the second control signaling includes a DCI message, a MAC-CE, RRC signaling, or a sequence.

In some examples, a single control message includes the first control signaling and the second control signaling.

In some examples, a first control message includes the first control signaling and a second control message includes the second control signaling.

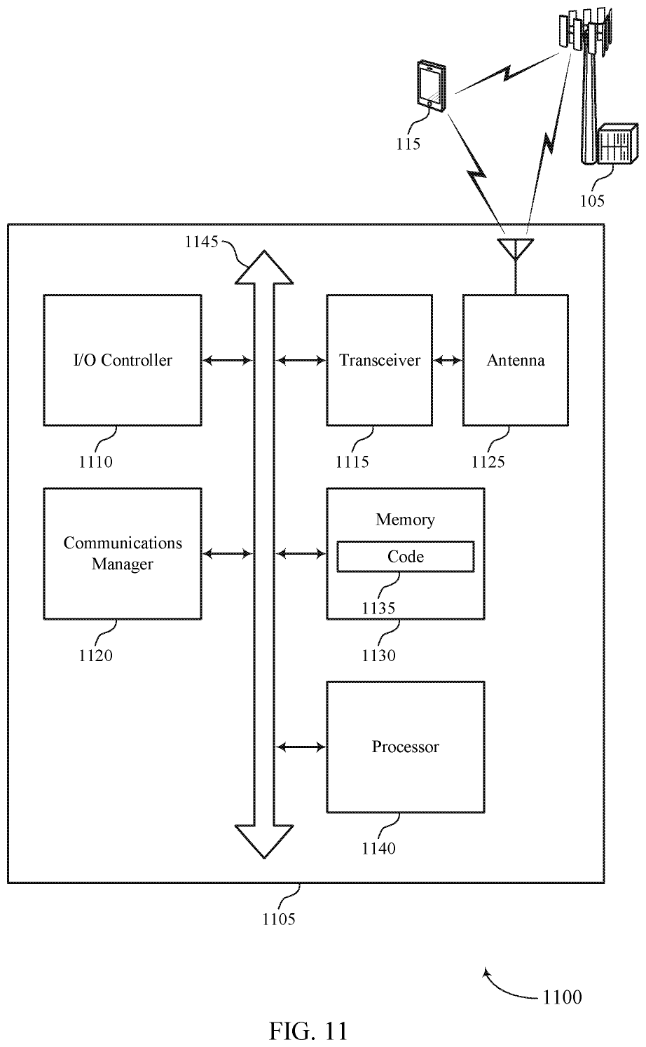

FIG. 11 shows a diagram of a system 1100 including a device 1105 that supports interference mitigation in RIS-based communication systems in accordance with one or more aspects of the present disclosure. The device 1105 may be an example of or include the components of a device 805, a device 905, or a RIS controller as described herein. The device 1105 may include components for bi-directional voice and data communications including components for transmitting and receiving communications, such as a communications manager 1120, an I/O controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting interference mitigation in RIS-based communication systems). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a RIS in accordance with examples as disclosed herein. For example, the communications manager 1120 may be configured as or otherwise support a means for receiving first control signaling indicating a configuration of radio resources for communicating signals between a network entity and one or more wireless devices via a set of reflective elements of the RIS. The communications manager 1120 may be configured as or otherwise support a means for receiving, from the network entity, second control signaling indicating a set of restricted locations for the signals reflected by the RIS and one or more restriction types associated with the set of restricted locations. The communications manager 1120 may be configured as or otherwise support a means for controlling the set of reflective elements of the RIS to reflect the signals according to the configuration based on the set of restricted locations and the one or more restriction types.

By including or configuring the communications manager 1120 in accordance with examples as described herein, the device 1105 may support techniques for a network entity to transmit a resource allocation and restrictions indication to a RIS controller, where the RIS controller generates a weighting matrix to apply to reflective elements of the RIS for beamforming based on the restrictions indication, which may provide for improved communication reliability, reduced latency, improved user experience related to reduced processing, reduced power consumption, more efficient utilization of communication resources, improved coordination between devices, longer battery life, and the like.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of interference mitigation in RIS-based communication systems as described herein, or the processor 1140 and the memory 1130 may be otherwise configured to perform or support such operations.

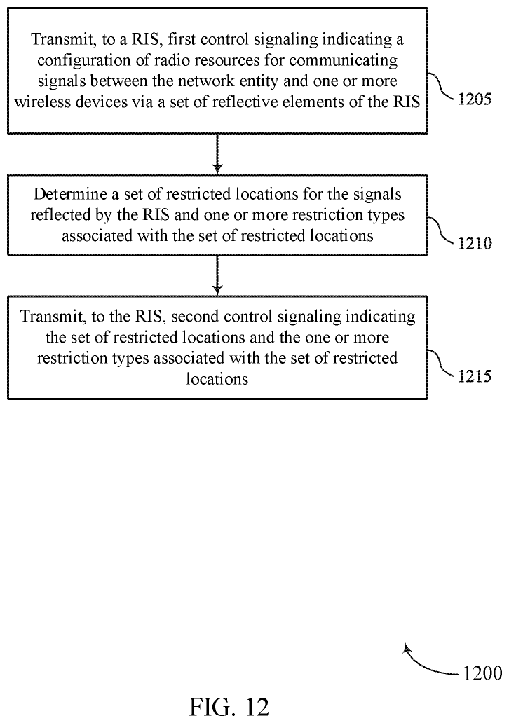

FIG. 12 shows a flowchart illustrating a method 1200 that supports interference mitigation in RIS-based communication systems in accordance with one or more aspects of the present disclosure. The operations of the method 1200 may be implemented by a network entity or its components as described herein. For example, the operations of the method 1200 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1205, the method may include transmitting, to a RIS, first control signaling indicating a configuration of radio resources for communicating signals between the network entity and one or more wireless devices via a set of reflective elements of the RIS. The operations of 1205 may be performed in accordance with examples as disclosed herein. In some examples, aspects of the operations of 1205 may be performed by a radio resource component 625 as described with reference to FIG. 6.

At 1210, the method may include determining a set of restricted locations for the signals reflected by the RIS and one or more restriction types associated with the set of restricted locations. The operations of 1210 may be performed in accordance with examples as disclosed herein. In some examples, aspects of the operations of 1210 may be performed by a locations component 630 as described with reference to FIG. 6.

At 1215, the method may include transmitting, to the RIS, second control signaling indicating the set of restricted locations and the one or more restriction types associated with the set of restricted locations. The operations of 1215 may be performed in accordance with examples as disclosed herein. In some examples, aspects of the operations of 1215 may be performed by a restrictions indication component 635 as described with reference to FIG. 6.

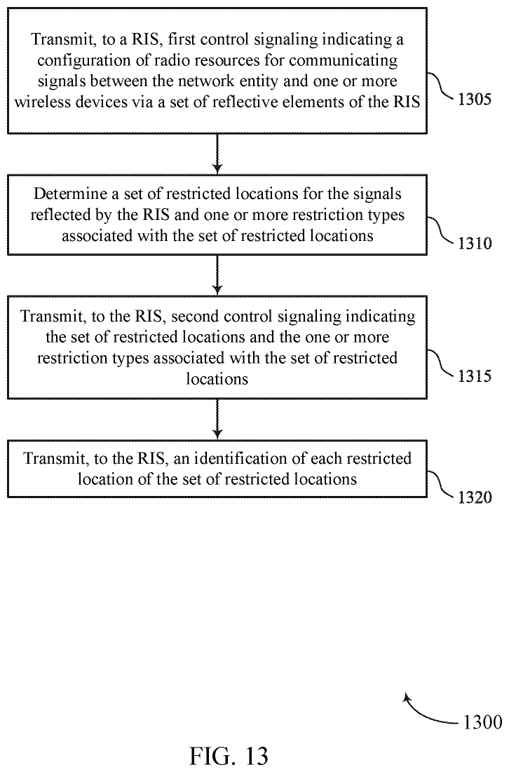

FIG. 13 shows a flowchart illustrating a method 1300 that supports interference mitigation in RIS-based communication systems in accordance with one or more aspects of the present disclosure. The operations of the method 1300 may be implemented by a network entity or its components as described herein. For example, the operations of the method 1300 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1305, the method may include transmitting, to a RIS, first control signaling indicating a configuration of radio resources for communicating signals between the network entity and one or more wireless devices via a set of reflective elements of the RIS. The operations of 1305 may be performed in accordance with examples as disclosed herein. In some examples, aspects of the operations of 1305 may be performed by a radio resource component 625 as described with reference to FIG. 6.

At 1310, the method may include determining a set of restricted locations for the signals reflected by the RIS and one or more restriction types associated with the set of restricted locations. The operations of 1310 may be performed in accordance with examples as disclosed herein. In some examples, aspects of the operations of 1310 may be performed by a locations component 630 as described with reference to FIG. 6.

At 1315, the method may include transmitting, to the RIS, second control signaling indicating the set of restricted locations and the one or more restriction types associated with the set of restricted locations. The operations of 1315 may be performed in accordance with examples as disclosed herein. In some examples, aspects of the operations of 1315 may be performed by a restrictions indication component 635 as described with reference to FIG. 6.

At 1320, the method may include transmitting, to the RIS, an identification of each restricted location of the set of restricted locations. The operations of 1320 may be performed in accordance with examples as disclosed herein. In some examples, aspects of the operations of 1320 may be performed by a restrictions indication component 635 as described with reference to FIG. 6.

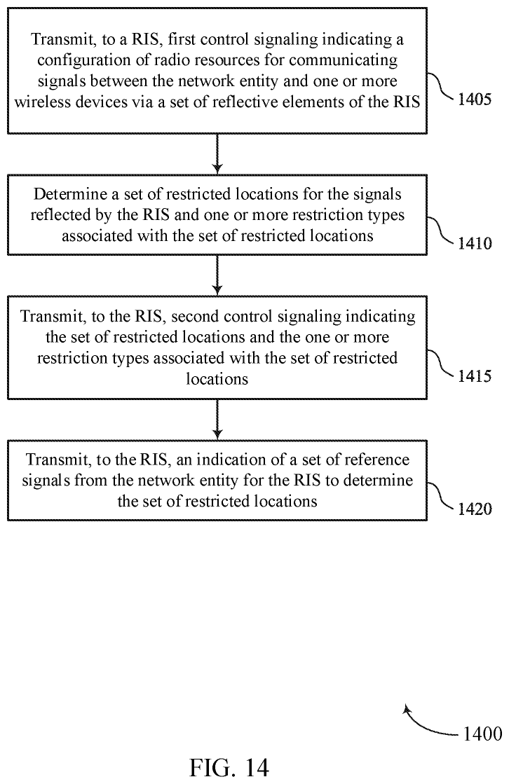

FIG. 14 shows a flowchart illustrating a method 1400 that supports interference mitigation in RIS-based communication systems in accordance with one or more aspects of the present disclosure. The operations of the method 1400 may be implemented by a network entity or its components as described herein. For example, the operations of the method 1400 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a RIS, first control signaling indicating a configuration of radio resources for communicating signals between the network entity and one or more wireless devices via a set of reflective elements of the RIS. The operations of 1405 may be performed in accordance with examples as disclosed herein. In some examples, aspects of the operations of 1405 may be performed by a radio resource component 625 as described with reference to FIG. 6.

At 1410, the method may include determining a set of restricted locations for the signals reflected by the RIS and one or more restriction types associated with the set of restricted locations. The operations of 1410 may be performed in accordance with examples as disclosed herein. In some examples, aspects of the operations of 1410 may be performed by a locations component 630 as described with reference to FIG. 6.

At 1415, the method may include transmitting, to the RIS, second control signaling indicating the set of restricted locations and the one or more restriction types associated with the set of restricted locations. The operations of 1415 may be performed in accordance with examples as disclosed herein. In some examples, aspects of the operations of 1415 may be performed by a restrictions indication component 635 as described with reference to FIG. 6.

At 1420, the method may include transmitting, to the RIS, an indication of a set of reference signals from the network entity for the RIS to determine the set of restricted locations. The operations of 1420 may be performed in accordance with examples as disclosed herein. In some examples, aspects of the operations of 1420 may be performed by a restrictions indication component 635 as described with reference to FIG. 6.

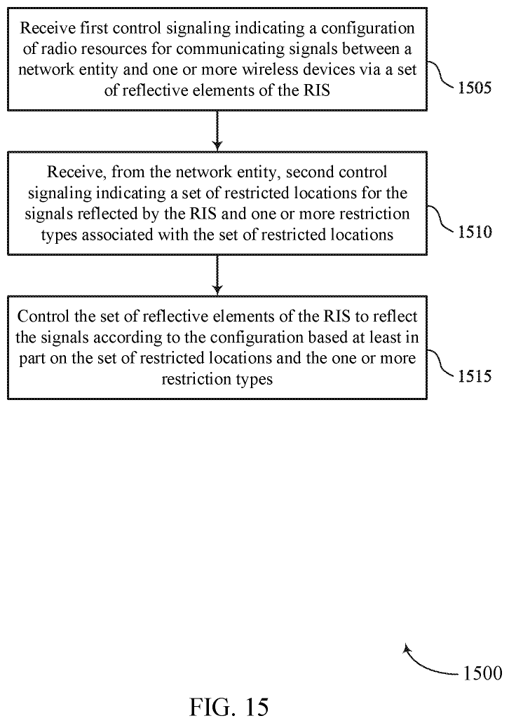

FIG. 15 shows a flowchart illustrating a method 1500 that supports interference mitigation in RIS-based communication systems in accordance with one or more aspects of the present disclosure. The operations of the method 1500 may be implemented by a RIS controller or its components as described herein. For example, the operations of the method 1500 may be performed by a RIS controller as described with reference to FIGS. 1 through 3 and 8 through 11. In some examples, a RIS controller may execute a set of instructions to control the functional elements of the RIS controller to perform the described functions. Additionally, or alternatively, the RIS controller may perform aspects of the described functions using special-purpose hardware.

At 1505, the method may include receiving first control signaling indicating a configuration of radio resources for communicating signals between a network entity and one or more wireless devices via a set of reflective elements of the RIS. The operations of 1505 may be performed in accordance with examples as disclosed herein. In some examples, aspects of the operations of 1505 may be performed by a radio resource manager 1025 as described with reference to FIG. 10.

At 1510, the method may include receiving, from the network entity, second control signaling indicating a set of restricted locations for the signals reflected by the RIS and one or more restriction types associated with the set of restricted locations. The operations of 1510 may be performed in accordance with examples as disclosed herein. In some examples, aspects of the operations of 1510 may be performed by a restrictions indication manager 1030 as described with reference to FIG. 10.

At 1515, the method may include controlling the set of reflective elements of the RIS to reflect the signals according to the configuration based on the set of restricted locations and the one or more restriction types. The operations of 1515 may be performed in accordance with examples as disclosed herein. In some examples, aspects of the operations of 1515 may be performed by a reflective element manager 1035 as described with reference to FIG. 10.

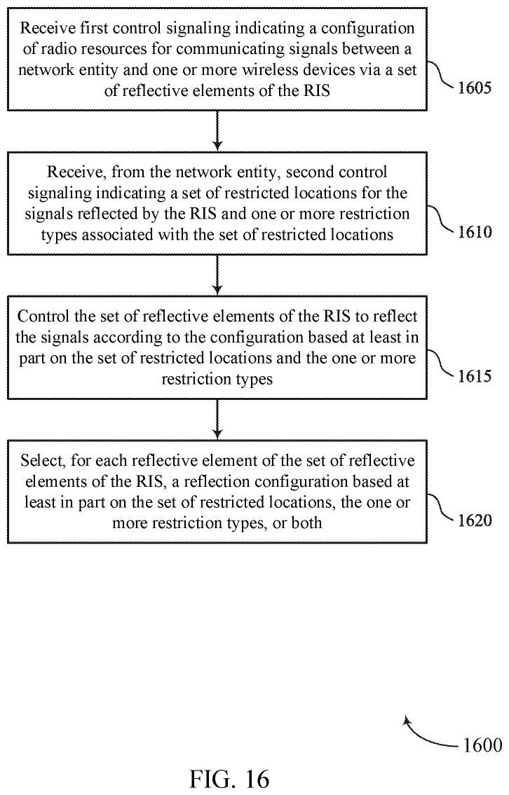

FIG. 16 shows a flowchart illustrating a method 1600 that supports interference mitigation in RIS-based communication systems in accordance with one or more aspects of the present disclosure. The operations of the method 1600 may be implemented by a RIS controller or its components as described herein. For example, the operations of the method 1600 may be performed by a RIS controller as described with reference to FIGS. 1 through 3 and 8 through 11. In some examples, a RIS controller may execute a set of instructions to control the functional elements of the RIS controller to perform the described functions. Additionally, or alternatively, the RIS controller may perform aspects of the described functions using special-purpose hardware.

At 1605, the method may include receiving first control signaling indicating a configuration of radio resources for communicating signals between a network entity and one or more wireless devices via a set of reflective elements of the RIS. The operations of 1605 may be performed in accordance with examples as disclosed herein. In some examples, aspects of the operations of 1605 may be performed by a radio resource manager 1025 as described with reference to FIG. 10.

At 1610, the method may include receiving, from the network entity, second control signaling indicating a set of restricted locations for the signals reflected by the RIS and one or more restriction types associated with the set of restricted locations. The operations of 1610 may be performed in accordance with examples as disclosed herein. In some examples, aspects of the operations of 1610 may be performed by a restrictions indication manager 1030 as described with reference to FIG. 10.

At 1615, the method may include controlling the set of reflective elements of the RIS to reflect the signals according to the configuration based on the set of restricted locations and the one or more restriction types. The operations of 1615 may be performed in accordance with examples as disclosed herein. In some examples, aspects of the operations of 1615 may be performed by a reflective element manager 1035 as described with reference to FIG. 10.

At 1620, the method may include selecting, for each reflective element of the set of reflective elements of the RIS, a reflection configuration based on the set of restricted locations, the one or more restriction types, or both. The operations of 1620 may be performed in accordance with examples as disclosed herein. In some examples, aspects of the operations of 1620 may be performed by a reflective element manager 1035 as described with reference to FIG. 10.

The following provides an overview of aspects of the present disclosure:

Aspect 1: A method for wireless communication at a network entity, comprising: transmitting, to a reconfigurable intelligent surface (RIS), first control signaling indicating a configuration of radio resources for communicating signals between the network entity and one or more wireless devices via a set of reflective elements of the RIS; determining a set of restricted locations for the signals reflected by the RIS and one or more restriction types associated with the set of restricted locations; and transmitting, to the RIS, second control signaling indicating the set of restricted locations and the one or more restriction types associated with the set of restricted locations.

Aspect 2: The method of aspect 1, wherein transmitting the second control signaling indicating the set of restricted locations comprises: transmitting, to the RIS, an identification of each restricted location of the set of restricted locations.

Aspect 3: The method of aspect 1, wherein transmitting the second control signaling indicating the set of restricted locations comprises: transmitting, to the RIS, an indication of a set of reference signals from the network entity for the RIS to determine the set of restricted locations.

Aspect 4: The method of any of aspects 1 through 3, wherein transmitting the second control signaling indicating the set of restricted locations comprises: transmitting, to the RIS, a set of restricted angles and a restriction type associated with each restricted angle.

Aspect 5: The method of any of aspects 1 through 4, wherein transmitting the second control signaling indicating the set of restricted locations comprises: transmitting, to the RIS, a set of restricted angles and associated distances and a restriction type associated with each restricted angle and associated distance.

Aspect 6: The method of any of aspects 1 through 5, wherein the second control signaling comprises a downlink control information message, a media access control-control element, radio resource control signaling, or a sequence.

Aspect 7: The method of any of aspects 1 through 6, wherein a single control message comprises the first control signaling and the second control signaling.

Aspect 8: The method of any of aspects 1 through 6, wherein a first control message comprises the first control signaling and a second control message comprises the second control signaling.

Aspect 9: The method of any of aspects 1 through 8, further comprising: receiving an indication of interference value from at least one wireless device of the one or more wireless devices; and adding, to the set of restricted locations, a restricted location associated with the at least one wireless device based at least in part on the interference value exceeding a threshold interference value.

Aspect 10: The method of any of aspects 1 through 9, further comprising: receiving, from a wireless node, joint scheduling information; determining that interference exists for at least one wireless device of the one or more wireless devices; and adding, to the set of restricted locations, a restricted location associated with the at least one wireless device based at least in part on the interference existing.

Aspect 11: A method for wireless communication at a reconfigurable intelligent surface (RIS), comprising: receiving first control signaling indicating a configuration of radio resources for communicating signals between a network entity and one or more wireless devices via a set of reflective elements of the RIS; receiving, from the network entity, second control signaling indicating a set of restricted locations for the signals reflected by the RIS and one or more restriction types associated with the set of restricted locations; and controlling the set of reflective elements of the RIS to reflect the signals according to the configuration based at least in part on the set of restricted locations and the one or more restriction types.

Aspect 12: The method of aspect 11, wherein receiving the second control signaling indicating the set of restricted locations comprises: receiving, from the network entity, an identification of each restricted location of the set of restricted locations.

Aspect 13: The method of aspect 11, wherein receiving the second control signaling indicating the set of restricted locations comprises: receiving an indication of a set of reference signals from the network entity; and determining, by the RIS, the set of restricted locations based at least in part on the set of restricted locations corresponding to the set of reference signals.

Aspect 14: The method of any of aspects 11 through 13, wherein receiving the second control signaling indicating the set of restricted locations comprises: receiving, from the network entity, a set of restricted angles and a restriction type associated with each restricted angle.

Aspect 15: The method of any of aspects 11 through 14, wherein receiving the second control signaling indicating the set of restricted locations comprises: receiving, from the network entity, a set of restricted angles and associated distances and a restriction type associated with each restricted angle and associated distance.

Aspect 16: The method of any of aspects 11 through 15, further comprising: selecting, for each reflective element of the set of reflective elements of the RIS, a reflection configuration based at least in part on the set of restricted locations, the one or more restriction types, or both.

Aspect 17: The method of aspect 16, wherein the reflection configuration comprises a coefficient amplitude and phase value for the each reflective element.

Aspect 18: The method of any of aspects 11 through 17, wherein controlling the set of reflective elements comprises: identifying that interference exists between a location of the one or more wireless devices and a restricted location; and generating a set of reflection coefficients for the set of reflective elements based at least in part on the set of restricted locations and the one or more restriction types.

Aspect 19: The method of any of aspects 11 through 18, wherein controlling the set of reflective elements comprises: identifying a lack of interference between a location of the one or more wireless devices and a restricted location; and generating a set of reflection coefficients for the set of reflective elements exclusive of the set of restricted locations and the one or more restriction types.

Aspect 20: The method of any of aspects 11 through 19, wherein the second control signaling comprises a downlink control information message, a media access control-control element, radio resource control signaling, or a sequence.

Aspect 21: The method of any of aspects 11 through 20, wherein a single control message comprises the first control signaling and the second control signaling.

Aspect 22: The method of any of aspects 11 through 20, wherein a first control message comprises the first control signaling and a second control message comprises the second control signaling.

Aspect 23: An apparatus for wireless communication at a network entity, comprising a processor; memory coupled with the processor; and instructions stored in the memory and executable by the processor to cause the apparatus to perform a method of any of aspects 1 through 10.

Aspect 24: An apparatus for wireless communication at a network entity, comprising at least one means for performing a method of any of aspects 1 through 10.

Aspect 25: A non-transitory computer-readable medium storing code for wireless communication at a network entity, the code comprising instructions executable by a processor to perform a method of any of aspects 1 through 10.

Aspect 26: An apparatus for wireless communication at a reconfigurable intelligent surface (RIS), comprising a processor; memory coupled with the processor; and instructions stored in the memory and executable by the processor to cause the apparatus to perform a method of any of aspects 11 through 22.

Aspect 27: An apparatus for wireless communication at a reconfigurable intelligent surface (RIS), comprising at least one means for performing a method of any of aspects 11 through 22.

Aspect 28: A non-transitory computer-readable medium storing code for wireless communication at a reconfigurable intelligent surface (RIS), the code comprising instructions executable by a processor to perform a method of any of aspects 11 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a network entity, comprising:
transmitting, to a reconfigurable intelligent surface (RIS), first control signaling indicating a configuration of radio resources for communicating signals between the network entity and one or more wireless devices via a set of reflective elements of the RIS;
determining a set of restricted locations for the signals reflected by the RIS and one or more restriction types associated with the set of restricted locations; and
transmitting, to the RIS, second control signaling indicating the set of restricted locations and the one or more restriction types associated with the set of restricted locations.

2. The method of claim 1, wherein transmitting the second control signaling indicating the set of restricted locations comprises:
transmitting, to the RIS, an identification of each restricted location of the set of restricted locations.

3. The method of claim 1, wherein transmitting the second control signaling indicating the set of restricted locations comprises:
transmitting, to the RIS, an indication of a set of reference signals from the network entity for the RIS to determine the set of restricted locations.

4. The method of claim 1, wherein transmitting the second control signaling indicating the set of restricted locations comprises:
transmitting, to the RIS, a set of restricted angles and a restriction type associated with each restricted angle.

5. The method of claim 1, wherein transmitting the second control signaling indicating the set of restricted locations comprises:
transmitting, to the RIS, a set of restricted angles and associated distances and a restriction type associated with each restricted angle and associated distance.

6. The method of claim 1, wherein the second control signaling comprises a downlink control information message, a media access control-control element, radio resource control signaling, or a sequence.

7. The method of claim 1, wherein a single control message comprises the first control signaling and the second control signaling.

8. The method of claim 1, wherein a first control message comprises the first control signaling and a second control message comprises the second control signaling.

9. The method of claim 1, further comprising:
receiving an indication of interference value from at least one wireless device of the one or more wireless devices; and
adding, to the set of restricted locations, a restricted location associated with the at least one wireless device based at least in part on the interference value exceeding a threshold interference value.

10. The method of claim 1, further comprising:
receiving, from a wireless node, joint scheduling information;
determining that interference exists for at least one wireless device of the one or more wireless devices; and
adding, to the set of restricted locations, a restricted location associated with the at least one wireless device based at least in part on the interference existing.

11. A method for wireless communication at a reconfigurable intelligent surface (RIS), comprising:
receiving first control signaling indicating a configuration of radio resources for communicating signals between a network entity and one or more wireless devices via a set of reflective elements of the RIS;
receiving, from the network entity, second control signaling indicating a set of restricted locations for the signals reflected by the RIS and one or more restriction types associated with the set of restricted locations; and
controlling the set of reflective elements of the RIS to reflect the signals according to the configuration based at least in part on the set of restricted locations and the one or more restriction types.

12. The method of claim 11, wherein receiving the second control signaling indicating the set of restricted locations comprises:
receiving, from the network entity, an identification of each restricted location of the set of restricted locations.

13. The method of claim 11, wherein receiving the second control signaling indicating the set of restricted locations comprises:
receiving an indication of a set of reference signals from the network entity; and
determining, by the RIS, the set of restricted locations based at least in part on the set of restricted locations corresponding to the set of reference signals.

14. The method of claim 11, wherein receiving the second control signaling indicating the set of restricted locations comprises:
receiving, from the network entity, a set of restricted angles and a restriction type associated with each restricted angle.

15. The method of claim 11, wherein receiving the second control signaling indicating the set of restricted locations comprises:
receiving, from the network entity, a set of restricted angles and associated distances and a restriction type associated with each restricted angle and associated distance.

16. The method of claim 11, further comprising:
selecting, for each reflective element of the set of reflective elements of the RIS, a reflection configuration based at least in part on the set of restricted locations, the one or more restriction types, or both.

17. The method of claim 16, wherein the reflection configuration comprises a coefficient amplitude and phase value for the each reflective element.

18. The method of claim 11, wherein controlling the set of reflective elements comprises:
identifying that interference exists between a location of the one or more wireless devices and a restricted location; and
generating a set of reflection coefficients for the set of reflective elements based at least in part on the set of restricted locations and the one or more restriction types.

19. The method of claim 11, wherein controlling the set of reflective elements comprises:
identifying a lack of interference between a location of the one or more wireless devices and a restricted location; and
generating a set of reflection coefficients for the set of reflective elements exclusive of the set of restricted locations and the one or more restriction types.

20. The method of claim 11, wherein the second control signaling comprises a downlink control information message, a media access control-control element, radio resource control signaling, or a sequence.

21. The method of claim 11, wherein a single control message comprises the first control signaling and the second control signaling.

22. The method of claim 11, wherein a first control message comprises the first control signaling and a second control message comprises the second control signaling.

23. An apparatus for wireless communication at a network entity, comprising:
a processor;
memory coupled with the processor; and
instructions stored in the memory and executable by the processor to cause the apparatus to:
transmit, to a reconfigurable intelligent surface (RIS), first control signaling indicating a configuration of radio resources for communicating signals between the network entity and one or more wireless devices via a set of reflective elements of the RIS;
determine a set of restricted locations for the signals reflected by the RIS and one or more restriction types associated with the set of restricted locations; and
transmit, to the RIS, second control signaling indicating the set of restricted locations and the one or more restriction types associated with the set of restricted locations.

24. The apparatus of claim 23, wherein the instructions to transmit the second control signaling indicating the set of restricted locations are executable by the processor to cause the apparatus to:
transmit, to the RIS, an identification of each restricted location of the set of restricted locations.

25. The apparatus of claim 23, wherein the instructions to transmit the second control signaling indicating the set of restricted locations are executable by the processor to cause the apparatus to:
transmit, to the RIS, an indication of a set of reference signals from the network entity for the RIS to determine the set of restricted locations.

26. The apparatus of claim 23, wherein the instructions to transmit the second control signaling indicating the set of restricted locations are executable by the processor to cause the apparatus to:
transmit, to the RIS, a set of restricted angles and a restriction type associated with each restricted angle.

27. The apparatus of claim 23, wherein the instructions to transmit the second control signaling indicating the set of restricted locations are executable by the processor to cause the apparatus to:
transmit, to the RIS, a set of restricted angles and associated distances and a restriction type associated with each restricted angle and associated distance.

28. An apparatus for wireless communication at a reconfigurable intelligent surface (RIS), comprising:
a processor;
memory coupled with the processor; and
instructions stored in the memory and executable by the processor to cause the apparatus to:
receive first control signaling indicating a configuration of radio resources for communicating signals between a network entity and one or more wireless devices via a set of reflective elements of the RIS;
receive, from the network entity, second control signaling indicating a set of restricted locations for the signals reflected by the RIS and one or more restriction types associated with the set of restricted locations; and
control the set of reflective elements of the RIS to reflect the signals according to the configuration based at least in part on the set of restricted locations and the one or more restriction types.

29. The apparatus of claim 28, wherein the instructions to receive the second control signaling indicating the set of restricted locations are executable by the processor to cause the apparatus to:
receive, from the network entity, an identification of each restricted location of the set of restricted locations.

30. The apparatus of claim 28, wherein the instructions to receive the second control signaling indicating the set of restricted locations are executable by the processor to cause the apparatus to:
receive an indication of a set of reference signals from the network entity; and
determine, by the RIS, the set of restricted locations based at least in part on the set of restricted locations corresponding to the set of reference signals.
